(19) United States
(12) Patent Application Publication
(10) Pub. No.: US 2008/0211411 A1
(43) Pub. Date: Sep. 4, 2008

(54) HIGH-PRESSURE DISCHARGE LAMP, HIGH-PRESSURE DISCHARGE LAMP OPERATING APPARATUS, AND ILLUMINATING APPARATUS

(75) Inventors: Kozo Uemura, Yokosuka-shi (JP); Hiroshi Kamata, Tokyo (JP); Masazumi Ishida, Yokosuka-shi (JP); Takuya Honma, Yokosuka-shi (JP)

Correspondence Address: DLA PIPER US LLP, P. O. BOX 9271, RESTON, VA, 20195, US

(73) Assignee: TOSHIBA LIGHTING & TECHNOLOGY CORPORATION, SHINAGAWA- KU (JP)

(21) Appl. No.: 11/859,394

(22) Filed: Sep. 21, 2007

(30) Foreign Application Priority Data
Sep. 22, 2006 (JP) 2006-257669
Sep. 25, 2006 (JP) 2006-259818
Sep. 25, 2006 (JP) 2006-259819
Sep. 25, 2006 (JP) 2006-259820
Dec. 22, 2006 (JP) 2006-346706

(51) Int. Cl. H01J 17/16

(52) U.S. Cl. 313/634

(57) ABSTRACT

A high-pressure discharge lamp includes a translucent ceramic discharge vessel having a surrounding part formed of translucent ceramic, and a pipe connected to the surrounding part, formed of translucent ceramic having an average crystal particle size of 50 μm or less in a region close to an intended sealing portion, and having a smaller diameter than the surrounding part. A current introducing conductor is inserted into the pipe of the translucent ceramic discharge vessel, and is sealed at least by a sealing portion formed by fusion of the translucent ceramic in the pipe. An electrode is connected to and disposed in the current introducing conductor in the translucent ceramic discharge vessel. A discharge medium is sealed in the translucent ceramic discharge vessel.

### CROSS-REFERENCE TO RELATED APPLICATIONS

This application is based upon and claims the benefit of priority from prior Japanese Patent Applications No. 2006-257669, filed Sep. 22, 2006; No. 2006-259818, filed Sep. 25, 2006; No. 2006-259819, filed Sep. 25, 2006; No. 2006-259820, filed Sep. 25, 2006; and No. 2006-346706, filed Dec. 22, 2006, the entire contents of all of which are incorporated herein by reference.

### BACKGROUND OF THE INVENTION

1. Field of the Invention

The present invention relates to a high-pressure discharge lamp provided with a translucent ceramic discharge vessel, and a high-pressure discharge lamp operating apparatus and an illuminating apparatus using the same.

2. Description of the Related Art

A conventional high-pressure discharge lamp provided with a translucent ceramic discharge vessel has a structure of sealing the discharge vessel by a current introducing conductor. Various modes have been proposed for this sealing, and especially the mode of using glass frit is most widely distributed (see, for example, Jpn. Pat. Appln. KOKAI Publication No. 6-196131).

However, when sealing the translucent ceramic discharge vessel by using the glass frit disclosed in the patent publication, since the heat resistance of the glass frit is not enough, the temperature of the sealing part must be suppressed in order to obtain a sufficient lamp life characteristic. For this purpose, the following structures are proposed.

(1) To form a pipe having a smaller diameter than a surrounding part from both ends of the surrounding part for defining the discharge space of the discharge vessel by extending the pipe in the axial direction of the surrounding part.

(2) To reduce the load of the tubular wall.

These structures may lead to the following problems.

By extending the pipe as in the structure of (1), the overall length of the discharge lamp becomes longer. As a result, the following problems are further caused.

(a) The pipe is easily to be broken.

(b) The sealing amount of discharge medium such as halide is increased by several times or more than ten times as compared with the required amount in a shorter pipe. As a result, the cost is increased, stability of the discharge medium declines, starting performance is reduced because of an increase in impurity gas released from the discharge medium, and white turbidity, blackening, and electrode wear are likely to occur.

Since the structure of (2) reduces the temperature, the halide is not evaporated sufficiently, and the vapor pressure cannot be raised. As a result, it is difficult to heighten the light emission efficiency to a desired degree. Although the light emission characteristic is favorable, it is difficult to use a halide of high reactivity.

Hence, Jpn. Pat. Appln. KOKAI Publication No. 2007-115651 proposed by the present applicant discloses a high-pressure discharge lamp having a current introducing conductor fused and fixed by ceramic of its vessel material at the opening of a translucent ceramic discharge vessel. In this invention, however, as a result of further studies by the inventors, it has been found that cracks may occur because of thermal impact before solidification by fusing of the ceramic of the vessel material, and it has been difficult to obtain discharge lamps having excellent sealing parts at high yield.

### BRIEF SUMMARY OF THE INVENTION

It is an object of the present invention to provide a high-pressure discharge lamp realizing a sealing portion of high reliability and high stability, a high-pressure discharge lamp operating apparatus and an illuminating apparatus using this high-pressure discharge lamp, in a structure of heating and fusing the pipe of a translucent ceramic discharge vessel, and fusing the pipe to the current introducing conductor inserted in the pipe.

According to a first aspect of the present invention, there is provided a high-pressure discharge lamp comprising:

a translucent ceramic discharge vessel having a surrounding part formed of translucent ceramic, and a pipe connected to the surrounding part, formed of translucent ceramic having an average crystal particle size of 50 μm or less in a region close to an intended sealing portion, and having a smaller diameter than the surrounding part;

a current introducing conductor inserted into the pipe of the translucent ceramic discharge vessel, and sealed at least by a sealing portion formed by fusion of the translucent ceramic in the pipe;

an electrode connected to and disposed in the current introducing conductor in the translucent ceramic discharge vessel; and

a discharge medium sealed in the translucent ceramic discharge vessel.

According to a second aspect of the present invention, there is provided a high-pressure discharge lamp comprising:

a translucent ceramic discharge vessel having a surrounding part, and a pipe connected to the surrounding part and having a smaller diameter than the surrounding part;

a current introducing conductor inserted into the pipe of the translucent ceramic discharge vessel, and sealed at least by a sealing portion formed by fusion of translucent ceramic in the pipe;

an electrode connected to and disposed in the current introducing conductor in the translucent ceramic discharge vessel; and

a discharge medium sealed in the translucent ceramic discharge vessel,

wherein a thermal conductivity difference between a portion of the pipe and a portion of the current introducing conductor, which are located the sealing portion, respectively, is 75 W/m·K or less.

According to a third aspect of the present invention, there is provided a high-pressure discharge lamp comprising:

a translucent ceramic discharge vessel having a surrounding part, and a pipe connected to the surrounding part and having a smaller diameter than the surrounding part;

a current introducing conductor inserted into the pipe of the translucent ceramic discharge vessel, and sealed at least by a sealing portion formed by fusion of translucent ceramic in the pipe;

an electrode connected to and disposed in the current introducing conductor in the translucent ceramic discharge vessel; and

a discharge medium sealed in the translucent ceramic discharge vessel,

wherein a linear expansion coefficient difference between a portion of the pipe and a portion of the current introducing conductor, which are located the sealing portion, respectively, is 4 ppm or less.

According to a fourth aspect of the present invention, there is provided a high-pressure discharge lamp comprising:

a translucent ceramic discharge vessel having a surrounding part, and a pipe connected to the surrounding part and having a smaller diameter than the surrounding part;

a current introducing conductor inserted into the pipe of the translucent ceramic discharge vessel, and sealed at least by a sealing portion formed by fusion of translucent ceramic in the pipe;

an electrode connected to and disposed in the current introducing conductor in the translucent ceramic discharge vessel; and

a discharge medium sealed in the translucent ceramic discharge vessel,

wherein a thermal conductivity difference between a portion of the pipe and a portion of the current introducing conductor, which are located the sealing portion, respectively, is 75 W/m·K or less, and a linear expansion coefficient difference between the same portions is 4 ppm or less.

According to a fifth aspect of the present invention, there is provided a high-pressure discharge lamp comprising:

a translucent ceramic discharge vessel having a surrounding part, and a pipe connected to the surrounding part and having a smaller diameter than the surrounding part;

a current introducing conductor inserted into the pipe of the translucent ceramic discharge vessel, and sealed at least by a sealing portion formed by fusion of translucent ceramic in the pipe;

an electrode connected to and disposed in the current introducing conductor in the translucent ceramic discharge vessel; and

a discharge medium sealed in the translucent ceramic discharge vessel,

wherein a ratio S_{W}/S_{T} is 0.037 to 0.363 where S_{T} is a sectional area of the pipe positioned closer to the sealing portion and S_{W} is a sectional area of the current introducing conductor positioned closer to the sealing portion.

According to a sixth aspect of the present invention, there is provided a high-pressure discharge lamp comprising

a translucent ceramic discharge vessel having a surrounding part, and a pipe connected to the surrounding part and having a smaller diameter than the surrounding part;

a current introducing conductor inserted into the pipe of the translucent ceramic discharge vessel, and sealed at least by a sealing portion formed by fusion of translucent ceramic in the pipe;

an electrode connected to and disposed in the current introducing conductor in the translucent ceramic discharge vessel; and

a discharge medium sealed in the translucent ceramic discharge vessel,

wherein a ratio φ_{S}/φ_{T} is 1 to 2, and a ratio L_{S}/φ_{T} is 1 to 3 where φ_{S} is a maximum outside diameter of the sealing portion, L_{S} is a length of the sealing portion, and φ_{T} is an outside diameter of the pipe positioned closer to the sealing portion.

According to a seventh aspect of the present invention, there is provided a high-pressure discharge lamp operating apparatus comprising:

the high-pressure discharge lamp according to any one of the first to sixth aspects; and

a lighting circuit which lights the high-pressure discharge lamp.

According to an eighth aspect of the present invention, there is provided an illuminating apparatus comprising:

an illuminating apparatus main body;

the high-pressure discharge lamp according to any one of the first to sixth aspects; and

a lighting circuit which lights the high-pressure discharge lamp.

### BRIEF DESCRIPTION OF THE SEVERAL VIEWS OF THE DRAWING

FIG. 1 is a front view of an entire structure of a metal halide lamp for an automobile headlight serving as a high-pressure discharge lamp according to a first embodiment of the invention;

FIG. 2 is a magnified sectional view of an arc tube in FIG. 1;

FIGS. 3A and 3B are an electron micrograph showing crystal particle size of polycrystal alumina ceramic on the outer surface of the pipe in FIG. 1, respectively;

FIGS. 4A to 4D are sectional views of a translucent ceramic discharge vessel having various shapes used in the high-pressure discharge lamp according to the first embodiment of the invention;

FIG. 5 is a block circuit diagram showing a high-pressure discharge lamp operating apparatus according to a seventh embodiment of the invention;

FIG. 6 is a schematic side view of the automobile headlight serving as an illuminating apparatus according to an eighth embodiment of the invention;

FIG. 7 is a graph showing the relation between average particle size and yield strength in a close region of an intended sealing portion of the pipe of the translucent ceramic discharge vessel in the high-pressure discharge lamp;

FIG. 8 is a sectional view showing the relation of dimensions of parts of the translucent ceramic discharge vessel assembled in the high-pressure discharge lamp;

FIG. 9 is a sectional view along the right-angle direction to the axial direction of the translucent ceramic discharge vessel in FIG. 8;

FIG. 10 is a graph showing the relation between ratio L/D_{O} of effective length L of the pipe to outside diameter D_{O} of pipe, and sealing amount of discharge medium;

FIG. 11 is a graph showing the relation between ratio D_{I}/t of inside diameter D_{I} of the pipe of the translucent ceramic discharge vessel to thickness t of the pipe in the high-pressure discharge lamp, and sealing amount of discharge medium;

FIG. 12 is a sectional view showing manufacture of a translucent ceramic discharge vessel of a high-pressure discharge lamp in Example 8;

FIG. 13 is a graph showing the relation between passing time and laser relative output in heating process of an intended sealing portion by laser emission;

FIG. 14 is a sectional view showing manufacture of a translucent ceramic discharge vessel of a high-pressure discharge lamp in Example 9;

FIG. 15 is a sectional view showing manufacture of a translucent ceramic discharge vessel of a high-pressure discharge lamp in Example 10;

FIG. 16 is a graph showing the relation among heat transfer rate difference between the pipe and the current introducing conductor of translucent ceramic discharge vessel in the sealing portion and minimum diameter that can be heated, temperature difference between the ceramic fusing portion and the opposite current introducing conductor position and resistance of the current introducing conductor;

FIG. 17 is a graph showing the relation among linear expansion coefficient difference between the pipe and the current introducing conductor of the translucent ceramic discharge vessel in the sealing portion, crack occurrence rate due to sealing and resistance of the current introducing conductor;

FIG. 18 is a sectional view of a high-pressure discharge lamp in Example 14 of the invention;

FIG. 19 is a perspective sectional view of the sealing portion in FIG. 18;

FIG. 20 is a graph showing the relation among sectional area ratio S_{W}/S_{T}, crack occurrence rate and power loss occurrence rate; and

FIG. 21 is a graph of lighting test results of high-pressure discharge lamps manufactured by varying the maximum outside diameter φ_{S} of the sealing portion, length L_{S} of the sealing portion, and outside diameter φ_{T} of the pipe positioned close to the sealing portion.

### DETAILED DESCRIPTION OF THE INVENTION

The high-pressure discharge lamp, high-pressure discharge lamp operating apparatus, and illuminating apparatus according to embodiments of the invention will be specifically described below.

### First Embodiment

A high-pressure discharge lamp according to a first embodiment includes a translucent ceramic discharge vessel having a surrounding part formed of translucent ceramic, and a pipe connected to the surrounding part, formed of translucent ceramic having an average crystal particle size of 50 μm or less in a region close to an intended sealing portion, and having a smaller diameter than the surrounding part. The discharge vessel has a discharge space formed inside so as to be airtight to outside. A current introducing conductor is inserted into the nope of the translucent ceramic discharge vessel, and is sealed at least by a sealing portion formed by fusion of translucent ceramic in the pipe. Electrodes are connected and disposed in the current introducing conductor in the translucent ceramic discharge vessel. A discharge medium is sealed in the translucent ceramic discharge vessel.

The translucent ceramic discharge vessel, current introducing conductor, electrodes, and discharge medium will be specifically described below.

[Translucent Ceramic Discharge Vessel]

Being translucent in the translucent ceramic discharge vessel means to be light permeable to such an extent that the light generated by discharge can be transmitted to outside, and it may not only be transparent, but also light diffusible. At least the portion for forming the discharge space in the discharge vessel may be translucent. If provided with, for example, additional structure aside from this portion, such structure may be non-translucent.

The translucent ceramic discharge vessel is composed of a single crystal metal oxide such as sapphire, and other Examples include polycrystal metal oxides such as semi-transparent airtight aluminum oxide (specifically translucent polycrystal alumina ceramic) yttrium-aluminum-garnet (YAG) and yttrium oxide (YOX), and polycrystal non-oxides such as light-permeable and heat-resistant aluminum nitride (AlN). In particular, translucent polycrystal alumina ceramic can be mass-produced industrially, and easily available relatively, and are hence ideal as the material for the translucent ceramic discharge vessel.

The surrounding part of the translucent ceramic discharge vessel has its inside discharge space formed in a proper shape, such as spherical, elliptical or circular columnar shape. The volume of the discharge space may be properly selected depending on the rated lamp power of the high-pressure discharge lamp, distance between electrodes, and the like. For example, in the case of a lamp for a liquid crystal projector, the volume may be 0.5 cc or less. In the case of a lamp for an automobile front light, it may be 0.05 cc or less. In the case of a general lighting lamp, the volume may be either smaller than or larger than 1 cc depending on the rated lamp power.

The pipe communicating with the surrounding part of the translucent ceramic discharge vessel has a current introducing conductor inserted therein, and when an intended sealing portion is heated and fused, the pipe cooperates with the current introducing conductor to form a sealing portion, thereby functioning to seal the translucent ceramic discharge vessel. The pipe also functions to seal the discharge medium in the translucent ceramic discharge vessel, that is, inside of the surrounding part.

The number of pipes in the translucent ceramic discharge vessel is two so as to be opposite to a pair of electrodes, but the number may be one or three or more depending on the number of current introducing conductors disposed. When two openings are provided for disposing a pair of electrodes, the pipes are located apart from each other. Preferably they are spaced from and opposite to each other along the axis. The ceramic of the pipes may be non-translucent.

The closest region of the intended sealing portion of the pipe of the translucent ceramic discharge vessel is 50 μm or less in average crystal particle size, more preferably 30 μm or less. That is, the average crystal particle size is 50 μm or less, preferably 30 μm or less in the intended sealing portion before fusion for sealing and including its closest region. The average crystal particle size of the closest region of the intended sealing portion of the pipe can be measured by observing the outer surface of the region by, for example, an electron microscope.

By setting the average crystal particle size at 50 μm or less in the region including the intended sealing portion, when sealing the pipe by fusing the ceramic, fitting with the current introducing conductor is improved. Moreover, in the cooling process after sealing of the pipe and the current introducing conductor by fusion, occurrence of cracks in the sealing portion and its vicinity is suppressed. In particular, by defining the average crystal particle size at 1 μm or less, occurrence of cracks at the time of sealing by fusing can be reduced effectively. Further, by determining the average crystal particle size at 0.5 μm or less, occurrence of cracks at the time of sealing by fusing can be avoided almost completely. Therefore, the average crystal particle size in the closest region of the intended sealing portion of the pipe is desired to be 0.1 to 30 μm, more preferably 0.5 to 20 μm.

In the translucent ceramic discharge vessel, the position having the average crystal particle size of 50 μm or less may be only the pipe, or may be part of the surrounding part connected to the pipe, or the entire discharge vessel.

The length of the pipe is not particularly specified, as long as it is long enough to easily form the sealing portion of the pipe with the current introducing conductor by fusing the ceramic. Evidently, the length of the pipe may be shorter than the length of the pipe when sealing by using the conventional frit glass. Specifically, the length of the pipe is 10 mm or less when the rated lamp power is 800 W or less, and 7 min or less when the rated lamp power is 100 W or less.

To seal the translucent ceramic discharge vessel, means for fusing the ceramic of the pipe is not particularly specified. For example, by heating the ceramic of the pipe over the melting temperature, the ceramic are fused, and fitted to the surface of the current introducing conductor inserted into the pipe. By cooling the fitted portion after heating, the ceramic are solidified, the current introducing conductor is fixed to the pipe, and the pipe is sealed. The means for heating the ceramic of the pipe includes, for example, local heating means of heat ray projection type such as laser and a halogen lamp with a reflector, induction heating means, and an electric heater. The laser may be, for example, YAG laser or CO₂ laser.

To heat the whole circumference of the intended sealing portion of the pipe by using the local heating means of heat ray projection type, the local heating means is located at a specified apart position from the intended sealing portion, for example, a sideward position from the intended portion, and while moving the local heating means, either one or both of the pipe of the translucent ceramic discharge vessel and the local heating means is rotated. In this manner, the entire circumference of the pipe can be heated uniformly. Note that, the translucent ceramic discharge vessel can be heated in standstill state by emitting the laser from extended direction of the pipe (for example, the axial direction), by disposing a plurality of local heating means around the fixed and disposed pipe, by rotating the local heating means around the pipe, or by disposing the heating means for surrounding the whole circumference of the pipe.

Thus, the intended sealing portion is heated and mainly the ceramic of the pipe is fused and sealed to the current introducing conductor, and the sealing portion is formed. This sealing portion is often a solid solution as the component of the current introducing conductor is solid and soluble. Preferably, the sealing portion, for example, the outer surface of the sealing portion is larger in the average crystal particle size than the outer surface of the non-sealing portion. The sealing portion of such mode has crystals grown in whole or part of the fused portion, and hence the crystal directions are random, and the heat resistance and mechanical strength are improved. As a result, breakage resistance and leak resistance by heat shock by lamp lighting car, be improved.

The translucent ceramic discharge vessel described above can be manufactured, for example, in the following method.

A translucent ceramic discharge vessel is manufactured by integrally forming the surrounding part and the pipe communicating therewith.

A translucent ceramic discharge vessel is manufactured by joining and fitting a plurality of component members. For example, the surrounding part and an accessory structure such as the pipe are separately sintered temporarily and joined as desired, and the entire structure is sintered, so that an integral translucent ceramic discharge vessel may be manufactured. Further, by separately sintering the pipe and the end plate portion temporarily, and bonding them, the entire structure is sintered, and an integrated surrounding part is formed, so that a translucent ceramic discharge vessel may be manufactured.

[Current Introducing Conductor]

The current introducing conductor functions to apply voltage to electrodes and supply current to the electrodes, and cooperate with the pipe to seal the translucent ceramic discharge vessel. The current introducing conductor has its leading end portion inserted in the pipe of the translucent ceramic discharge vessel and connected electrically to the electrodes, and its base end portion exposed outside of the translucent ceramic discharge vessel. Being exposed outside of the translucent ceramic discharge vessel means that it is exposed outside to such an extent that the power can be supplied from outside, whether projecting out or not from the translucent ceramic discharge vessel.

The current introducing conductor is formed of a sealing metal or cermet. The sealing metal may be a conductive metal of which thermal expansion factor is similar to that of the translucent ceramic of the pipe of the discharge vessel, such as niobium (Nb), tantalum (Ta), titanium (Ti), zirconium (Zr), hafnium (Hf), vanadium (V), platinum (Pt), molybdenum (Mo), and tungsten (W). In particular, niobium and tantalum are suited for sealing when polycrystal alumina ceramic or other aluminum oxides are used as translucent ceramic as material for the translucent ceramic discharge vessel because the average thermal expansion factor is nearly the same as that of aluminum oxide. Molybdenum similarly suited for sealing because its average thermal expansion factor is similar to that of aluminum oxide. Niobium, tantalum, and molybdenum are preferred because the difference in average thermal expansion factor is smaller in the case of translucent ceramic of yttrium oxide and YAG. Zirconium is desired when aluminum nitride is used in the translucent ceramic discharge vessel.

Cermet is a mixed sinter of ceramic and metal, composed of, for example, alumina ceramic and at least one metal selected from the group mentioned above, for example, molybdenum or tungsten.

The current introducing conductor may be formed by bonding plural materials. For example, a part may be formed of a metal selected from the above group, and cermet may be bonded to this metal in the axial direction, or may be bonded in a peripheral direction orthogonal to the axis. When using cermet at least in portion of the current introducing conductor, by sealing the pipe of the translucent ceramic discharge vessel and the current introducing conductor at the cermet position, temperature rise of ceramic is easy at the time of sealing by fusing the ceramic of the pipe, and the sealing portion may be formed more favorably.

The cermet in the sealing portion of the translucent ceramic discharge vessel with the current introducing conductor contains at least metal components such as niobium (Nb), molybdenum (Mo) and tungsten, and ceramic components such as alumina, YAG, and yttria, and the content ratio of metal component is desired to be 5 to 60 mass %. By defining the content of metal component at 60 mass % or less, the thermal expansion factor of the current introducing conductor containing the cermet may be approximated to that of the translucent ceramic discharge vessel. As a result, as compared with a case of direct contact of the translucent ceramic discharge vessel and molybdenum, it is possible to improve the breakage resistance and leak resistance by heat shock when lighting the high-pressure discharge lamp.

In the current introducing conductor containing the cermet of such composition, when the intended sealing portion is heated by heating means, generally, heat absorption is unlikely to occur in the translucent ceramic discharge vessel, while the heat absorption increases on the cermet surface. As a result, the cermet surface of the current introducing conductor is heated and the temperature rises, the heat is transferred to the pipe of the translucent ceramic discharge vessel, and the intended sealing portion is fused.

The cermet used in the current introducing conductor is desired to have a content of metal component in the range of 50 to 80 mass % from other viewpoint. That is, if emphasis is placed on the conductivity of the cermet, by defining the content ratio of metal component in this range, a current introducing conductor having sufficient conductivity can be obtained. The current introducing conductor having the cermet of such composition can be reduced in diameter, and thus the current introducing conductor and the pipe of the discharge vessel can be sealed more easily.

If the content of metal component in the cermet exceeds 80 mass %, the thermal expansion factor difference is too large between the cermet of the current introducing conductor and the translucent ceramic discharge vessel, making it difficult to obtain a desired sealing. If the content of metal component in the cermet is less than 50 mass %, it is difficult to obtain a current introducing conductor having a desired conductivity.

In the current introducing conductor composed of the cermet at least in the intended sealing portion, it may be formed in a concentric inclined structure, in which a first cermet of favorable conductive composition is placed at the central side, and a second cermet of favorable sealing composition is placed at both sides of the first cermet. The first and second cermet members may be formed in a stepped inclined structure or stepless inclined structure.

The current introducing conductor functions to seal to the pipe of the translucent ceramic discharge vessel, and to support the electrodes. To optimize these functions, the corresponding portions are formed of different materials, or formed in different sizes, and these portions may be connected in the axial direction to compose a current introducing conductor. For example, the cermet is used in the portion to be sealed to the pipe of the translucent ceramic discharge vessel, molybdenum or other metal resistant to halogenation is used in the portion for supporting the electrodes, and these portions may be sealed with frit glass. In the current introducing conductor of the first embodiment, by varying the material, size, shape and specification depending on the functions, these different portions may be connected in the axial direction to compose an entire structure. Besides, the current introducing conductor may be also made of conductive members of similar materials throughout its overall length.

[Electrode]

The electrode is the means for generating discharge of discharge medium inside the translucent ceramic discharge vessel. At least one electrode is connected to the current introducing conductor, and is sealed in the translucent ceramic discharge vessel. Typically, a pair of electrodes is disposed oppositely apart from each other so as to generate arc discharge inside the translucent ceramic discharge vessel. The electrodes are connected to the leading end so that the base end thereof may be positioned at the inner side of the translucent ceramic discharge vessel of the current introducing conductor.

The electrodes are composed of electrode principal portions and/or electrode axial portions. The electrode principal portion is the discharge starting point, and acts as negative electrode and/or positive electrode. The electrode principal portion can be connected directly to the current introducing conductor without passing through the electrode axial portion. The electrode principal portion may be increased in surface area and improved in heat release property by, as required, winding a tungsten coil or increasing the diameter than the electrode axial portion. When the electrode includes the electrode axial portion, the electrode axial portion projects backward from the back side of the electrode principal portion together with the electrode principal portion or by welding, supports the electrode principal portion, and is connected to the current introducing conductor. The leading ends of the electrode axial portion and the current introducing conductor may be integrated by tungsten.

Materials for the electrodes include, for example, tungsten, doped tungsten, thoriated tungsten, rhenium, and tungsten-rhenium alloy.

When using a pair of electrodes, in the case of alternating-current lighting, they are disposed in a symmetrical structure. In the case of direct-current lighting, a pair of electrodes is disposed in a non-symmetrical structure.

[Discharge Medium]

The discharge medium is the means for obtaining desired light emission by discharge, and is not particularly specified. Examples thereof include the following modes.

(1) Discharge medium in combination of halide of luminous metal+mercury+rare gas. This discharge medium is used in a metal halide lamp containing mercury.

(2) Discharge medium in combination of halide luminous metal+halide as lamp voltage forming medium+rare gas. This discharge medium is used in a so-called mercury-free metal halide lamp not containing mercury of large environmental load.

(3) Discharge medium in combination of mercury+rare gas. This discharge medium is used in a high-pressure mercury lamp.

(4) Discharge medium composed of rare gas Xe. This discharge medium is used in a xenon lamp.

The halide of luminous metal is a halide of luminous metal mainly emitting visible light, and any known halide of various metals may be used. That is, the halide of luminous metal may be freely selected from known metal halides for obtaining emission of visible light of desired emission characteristics about emission color, average color rendition evaluation number Ra and emission efficiency, or depending on the size and input power of the translucent ceramic discharge vessel. Examples of the halide of luminous metal include iodide, bromide, chloride, fluoride and other halides of one or two or more metals selected from the group consisting of sodium (Na), scandium (Sa), rare earth metals (such as dysprosium (Dy), thulium (Tm), holmium (Ho), praseodymium (Pr), lanthanum (La), and cerium (Ce)), thallium (Tl), indium (In), and lithium (Li).

The lamp voltage forming medium is a medium effective for forming a lamp voltage, and a halide of mercury or following metals may be used. The halide as the lamp voltage forming medium is preferably a metal relatively large in vapor pressure during lighting, and smaller in light emission amount in visible region as compared with the light emission amount in visible region by luminous metal, for example, aluminum (Al), iron (Fe), zinc (Zn), antimony (Sb), manganese (Mn) and other halides.

The rare gas acts as starting gas or buffer gas, and includes xenon (Xe), argon (Ar), krypton (Kr), neon (Ne) and the like, which may be used either alone or in mixture.

Among the discharge media (1) to (4), in particular, combinations of halide of luminous metal, lamp voltage forming medium, and rare gas are preferred.

In the first embodiment, “high-pressure discharge” of the high-pressure discharge lamp means that the pressure during lighting of ionizing medium is over the atmospheric pressure, which includes so-called superhigh-pressure discharge.

In the high-pressure discharge lamp in the first embodiment of the invention, other preferable modes will be explained below. These modes may be executed either independently or in proper combination.

1) High-pressure discharge lamp in which the ratio L/D_{O} of effective length L of the pipe and outside diameter D_{O} of the pipe of the translucent ceramic discharge vessel is 0.5 to 3.0.

By defining the ratio L/D_{O} in the range of 0.5 to 3.0, the amount of discharge medium to be charged inside the translucent ceramic discharge vessel may be decreased. The effective length L of the pipe is the length of the pipe in the axial direction excluding the sealing portion. The outside diameter D_{O} of the pipe is the outside diameter at a position adjacent to the sealing portion of the pipe.

The reason for defining the ratio L/D_{O} is that, in the case of the high-pressure discharge lamp in the first embodiment, the length L of the pipe required for forming the sealing of the translucent ceramic discharge vessel varies depending on the outside diameter D_{O} of the pipe, and that the length of the pipe depends on the amount of the discharge medium staying inside, that is, the sealing amount of the discharge medium.

By defining the ratio L/D_{O} in this range, the sealing amount of the discharge medium necessary for obtaining a desired lamp characteristic may be saved relatively. If the ratio L/D_{O} exceeds 3.0, the amount of metal halide or other discharge medium aggregating in the coldest portion formed in the pipe during lighting is extremely increased. As a result, the sealing amount of discharge medium necessary for light emission must be increased. This phenomenon occurs particularly when D_{O} is 1.0 to 5.0 mm and L is 0.5 to 15 mm. If the ratio L/D_{O} is less than 0.5, the sealing amount of discharge medium is less, but the pipe is too short or the outside diameter thereof is too large, and it is difficult to seal the translucent ceramic discharge vessel favorably.

2) High-pressure discharge lamp in which the ratio D_{I}/t of inside diameter D_{I} of the pipe to thickness t of the pipe of the translucent ceramic discharge vessel is 1.4 to 17, where the inside diameter D_{I} of the pipe and the thickness t of the pipe i.e. wall thickness t of the pipe are those of the position close to the sealing portion of the pipe.

By defining such ratio D_{I}/t, it is effective to save the amount of discharge medium contained inside the translucent ceramic discharge vessel.

The reason for defining the ratio D_{I}/t is that, in the case of the high-pressure discharge lamp of the first embodiment, the inside diameter D_{I} of the pipe relating to desired sealing of the translucent ceramic discharge vessel depends on the thickness t of the pipe, and that the amount of discharge medium staying in the pipe, that is, the sealing amount of discharge medium depends on the Inside diameter of the pipe.

By defining the ratio D_{I}/t in the above range, the sealing amount of discharge medium necessary for obtaining a desired lamp characteristic may be relatively saved. If the ratio D_{I}/t exceeds 17, the amount of discharge medium such as metal halide aggregated in the coldest part formed in the pipe while the lamp is lighting is increased suddenly. As a result, it is necessary to increase the sealing amount of discharge medium necessary for illumination. This phenomenon is manifest when D_{I} is 0.5 to 1.5 mm and t is 0.3 to 2.0 μm. On the other hand, if the ratio D_{I}/t is less than 1.4, the required sealing amount of discharge medium is smaller, but the pipe is too short or the outside diameter thereof is too large, and it is difficult to seal the translucent ceramic discharge vessel favorably. An optimum range of the ratio D_{I}/t is 1.6 to 2.5.

3) Mercury-free high-pressure discharge lamp in which the average crystal particle size in the entire translucent ceramic discharge vessel is 50 μm or less, more preferably 0.5 to 20 μm, and the sealing pressure of xenon of discharge medium at 25° C. is 0.3 to 2 MPa, more preferably 0.5 to 1.2 MPa.

In the case of the translucent ceramic discharge vessel having the pipe, since stress is concentrated on the pipe, the pipe is likely to be broken if the pressure-proof strength is insufficient in the translucent ceramic discharge vessel.

By defining the sealing pressure of xenon in the specified range, breakage of the translucent ceramic discharge vessel and its pipe during lighting can be prevented without sacrificing the pressure-proof strength of the translucent ceramic discharge vessel, and a desired luminous flux rising characteristic can be obtained, at the same time.

In the high-pressure discharge lamp of the first embodiment, the translucent ceramic discharge vessel may be either exposed to the atmosphere or contained in an outer tube. The outer tube may be either vacuum, or filled with gas or atmosphere communicating with the outside air. In the high-pressure discharge lamp of the first embodiment, a reflector may be formed integrally.

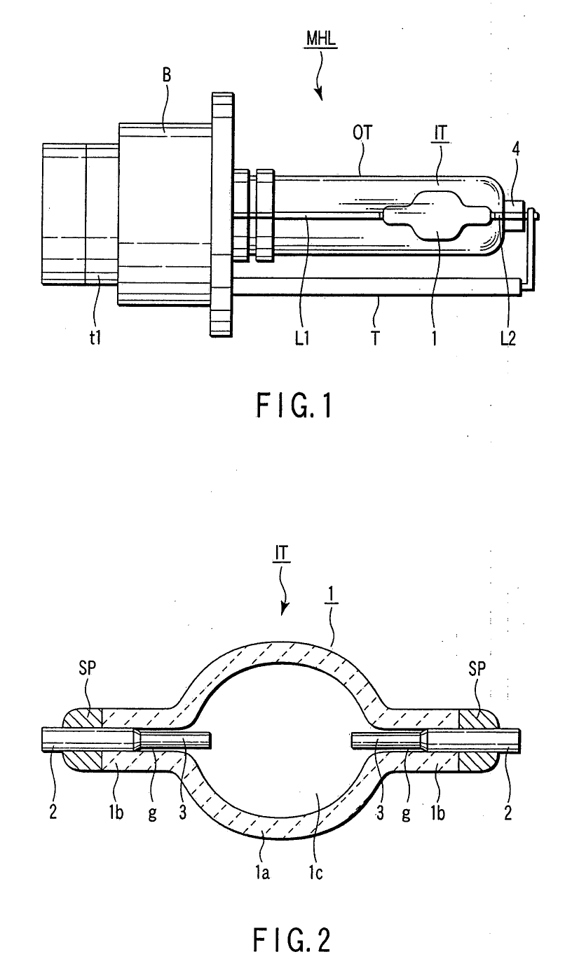

The high-pressure discharge lamp of the first embodiment, for example, a metal halide lamp for an automobile headlight will be specifically explained by referring to FIGS. 1 and 2. FIG. 1 is a sectional view of a metal halide lamp for an automobile headlight, and FIG. 2 is a magnified sectional view of a arc tube of FIG. 1.

A metal halide lamp MHL for an automobile headlight is composed of an arc tube IT, lead wires L1, L2, an insulating tube T, an outer tube OT and a base B.

The arc tube IT is composed of, as shown in FIG. 2, a translucent ceramic discharge vessel 1, current introducing conductors 2, electrodes 3, and discharge medium sealed in the discharge vessel 1, and includes sealing portions SP.

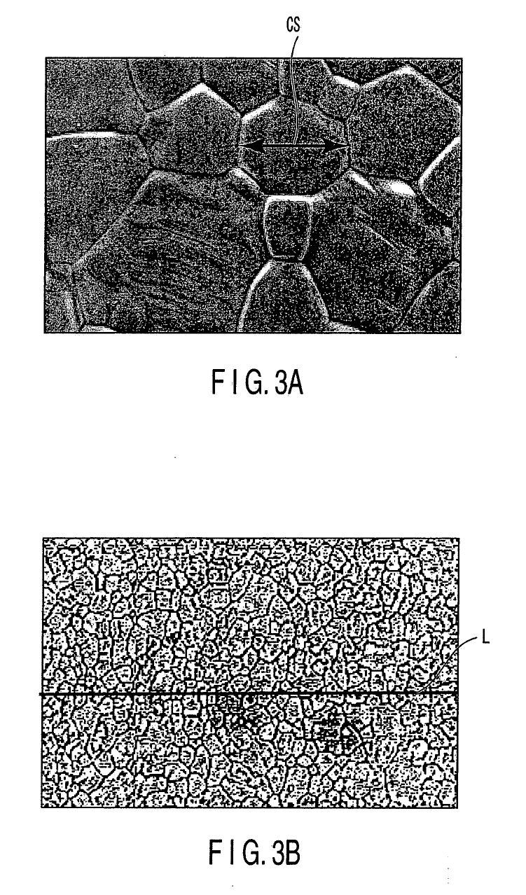

The translucent ceramic discharge vessel 1 is formed by integrally forming translucent ceramic of average crystal particle size of 50 μm or less, preferably 30 μm or less, such as translucent polycrystal alumina ceramic as shown in FIG. 2. The discharge vessel 1 includes a surrounding part 1a, and a pipe 1b connected to the surrounding part 1a and having a smaller diameter than the surrounding part 1a. The average crystal particle size CS is easily recognized by magnifying the outer surface of the pipe 1b by an electron microscope as shown in FIG. 3A. For example, as shown in FIG. 3B, a reference straight line L having a length of about 100 times of the average crystal particle size is set at a proper position in an electron microscope image on the outer surface of the translucent polycrystal alumina ceramic. An average of the diameters of multiple crystal particles intersecting with the reference line can be determined as the average crystal particle size.

The surrounding part 1a is formed like a hollow spindle of uniform wall thickness, and a discharge space 1c of the same shape is formed inside. The inner volume of the discharge space 1c is about 0.05 cc or less. A pair of pipes 1b, 1b are extended integrally from both ends of the surrounding part 1a in the axial direction, and the sealing portion SP is formed at each end side.

The sealing portion SP is formed by fusing and solidifying the ceramic of the pipe 1b in the intended sealing portion as shown in FIG. 2.

The current introducing conductor 2 is formed of, for example, cermet, is inserted into each pipe 1b of the translucent ceramic discharge vessel 1, and is sealed by fusion with ceramic of at least one pipe 1b, thereby sealing the translucent ceramic discharge vessel 1. Such current introducing conductor 2 has its leading end positioned in the pipe 1b, and the base end exposed outside of the translucent ceramic discharge vessel 1. When sealing the current introducing conductor 2, the pipe 1b is heated and fused sufficiently, and tends to bulge out in the radial direction while condensing in the axial direction by surface tension, thereby being deformed in elliptical shape or teardrop shape. The pipe 1b may be processed in various shapes depending on the heating time, temperature and other processing factors.

The electrodes 3 are made of, for example, tungsten wires, and are identical in the diameter of the shaft at the leading end, middle position, and base end in the axial direction. Part of the leading end and middle position of the electrodes 3 is exposed in the discharge space 1c. The electrodes 3 have the base ends welded and connected to the leading ends of the current introducing conductors 2, and are supported along the axial direction of the translucent ceramic discharge vessel 1. A slight gap g is formed in the axial direction between the middle position of the electrodes 3 and the inner surface of the pipe 1b. This gap can be evidently shorter than that of the conventional high-pressure discharge lamp having the translucent ceramic discharge vessel sealed by using frit glass.

The discharge medium is formed of, for example, halide of luminous metal, lamp voltage forming medium, and rare gas. The lamp voltage forming medium is mercury or lamp voltage forming halide. The lamp voltage forming halide is a halide of a metal high in vapor pressure, and relatively smaller in light emission amount of a visible region than in light emission amount of luminous metal, in coexistence with halide of luminous metal.

The lead wires L1, L2 have the leading ends welded and connected to the base ends of the current introducing conductors 2, 2, and are supporting the arc tube IT. The lead wire L1 is extended along the axial direction, guided into the base B described below, and connected to other base terminal (not shown) of a pin shape disposed in the center. The lead wire L2 has its middle position folded along the outer tube OT described below, is guided into the base B, and is connected to one base terminal t1 of ring shape disposed on the outer circumference of the base B.

The insulating tube T is made of ceramic, and covers the lead wire L2.

The outer tube OT has an ultraviolet shielding performance, and contains the arc tube IT in its inside. Tapered portions 4 at both ends of the outer tube OT (only the right end side is shown in the drawing) are fused with glass to the lead wire L2. The inside of the cuter tube OT is not airtight, but communicates with the atmosphere.

The base B is standardized for an automobile headlight, supports the arc tube IT and outer tube OT in upright position along the central axis, and is detachably fitted to the inside from the back side of the automobile headlight. The base B has one base terminal t1 and other base terminal. The one base terminal t1 is formed in a ring shape disposed on the outer circumference of tubular part so as to contact with the lamp socket of the power supply side when mounting. The other base terminal is formed in a pin shape disposed by extending in the axial direction in the center in a recess at one open side formed inside the tubular part.

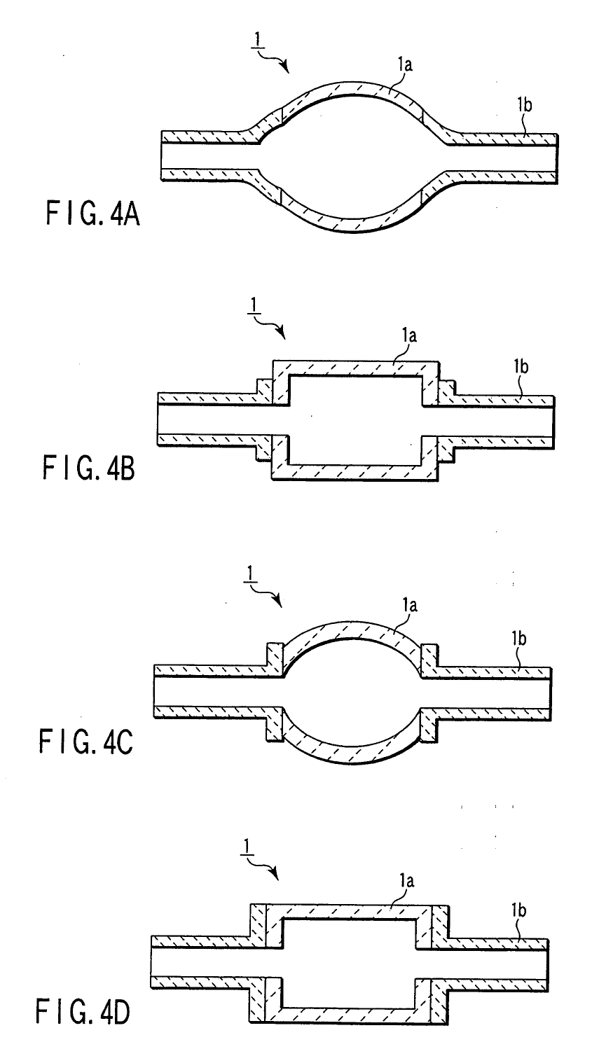

In the high-pressure discharge lamp of the first embodiment of the invention, the surrounding part and the pipe of the translucent ceramic discharge vessel can be formed by using translucent ceramic mutually different in linear transmissivity, and their functions can be optimized. The translucent ceramic discharge vessel of such configuration will be described below by referring to FIGS. 4A to 4D. In FIGS. 4A to 4D, principal parts of the surrounding part 1a are formed of ceramic of high linear transmissivity, for example, single crystal alumina or translucent polycrystal alumina ceramic of high linear transmissivity. The pipe 1b is formed of polycrystal alumina ceramic of average crystal particle size of 50 μm or less, preferably 30 μm or less. To manufacture the translucent ceramic discharge vessel 1 composed of such two different members, a known ceramic member manufacturing technology may be employed such as shrinkage-fit structure.

FIG. 4A shows a translucent ceramic discharge vessel 1 in which a spindle-like surrounding part 1a having both ends cut off, and a pipe 1b integrated to the surrounding part 1a by expanding the leading end are, for example, sintered temporarily and prepared, and these members are assembled and contained in a molding die, and sintered and formed integrally.

FIG. 4B shows a translucent ceramic discharge vessel 1 in which a surrounding part 1a having a pair of end plates having an opening provided at both ends of a tubular body formed integrally, and a pipe 1b having a smaller flange than the outside diameter of the end plate of the surrounding part 1a are sintered separately and prepared, and the flange of the pipe 1b is bonded to the end plates at both ends of the surrounding part 1a so that the both openings may coincide with each other, and the two members are shrinkage-fitted.

FIG. 4C shows a translucent ceramic discharge vessel 1 of the same shrinkage-fit structure as in FIG. 4B, in which the surrounding part 1a is formed in a spindle shape.

FIG. 4D shows a translucent ceramic discharge vessel 1 nearly the same as in FIG. 4B, in which the outside diameter of the flange of the pipe 1b is equal to that of the surrounding part 1a.

According to the first embodiment of the invention, as described herein, in the sealing structure for heating and fusing the intended sealing portion of the translucent ceramic discharge vessel, and attaching to the current introducing conductor, at least the pipe of the translucent ceramic discharge vessel is formed of translucent ceramic of which average crystal particle size in a region close to the intended sealing portion is 50 μm or less. Therefore, a high-pressure discharge lamp capable of suppressing occurrence of cracks in the ceramic in the sealing portion can be provided.

Besides, since the average crystal particle size of ceramic in the sealing portion is larger than that of ceramic in the non-sealing portion, the heat resistance and mechanical strength in the sealing portion can be enhanced. As a result, a high-pressure discharge lamp of high reliability and high stability can be provided.

### Second Embodiment

A high-pressure discharge lamp according to a second embodiment is basically similar to that of the first embodiment, including a translucent ceramic discharge vessel, a current introducing conductor, electrodes and discharge medium. In this lamp, the current introducing conductor is inserted in the pipe of the translucent ceramic discharge vessel, and at least in the sealing portion formed by fusing the translucent ceramic in the pipe, the thermal conductivity difference between the pipe and the current introducing conductor is 75 W/m·K or less. That is, a thermal conductivity difference between a portion of the pipe and a portion of the current introducing conductor, which are located the sealing portion, respectively, is 75 W/m·K or less.

In the region close to the intended sealing portion of the pipe of the translucent ceramic discharge vessel is desired to be 50 μm, or less in average crystal particle size for the reasons explained above, more preferably 30 μm or less. In particular, by defining the average crystal particle size at 1 μm or less, occurrence of cracks can be extremely suppressed when bonding by fusing. Further, by defining the average crystal particle size at 0.5 μm or less, cracks can be avoided almost completely when bonding by fusing. Therefore, in the region close to the intended sealing portion of the pipe, the average crystal particle size is desired to be 0.1 to 30 μm, more preferably 0.5 to 20 μm.

The material for the current introducing conductor is selected from sealing metal and cermet so that the thermal conductivity difference may be 75 W/m·K or less, 1.5 more preferably 58 W/m·K or less from the ceramic in the pipe of the translucent ceramic discharge vessel. When the thermal conductivity difference is 75 W/m·K or less, the minimum heating diameter of the current introducing conductor can be sufficiently reduced when fusing for sealing, and the temperature difference can be decreased between the ceramic of the pipe and the current introducing conductor. As a result, sealing is realized even if the fusing portion size is decreased, and thus the sealing portion can be reduced in size. As the sealing portion becomes smaller, occurrence of cracks is decreased, and a favorable sealing is achieved.

In particular, when the thermal conductivity difference is 58 W/m·K or less, it is easier to heat the intended sealing portion locally by limiting the target, the temperature difference is further reduced between the ceramic of the pipe and the current introducing conductor, and cracks are further suppressed, thereby achieving favorable sealing.

By contrast, if the thermal conductivity difference between the pipe and the current introducing conductor exceeds 75 W/m·K, generally, the heat conductivity of the current introducing conductor relatively increases. Therefore, when heating by inserting the current introducing conductor in the pipe of the translucent ceramic discharge vessel, the rate of the heat escaping through the current introducing conductor increases. As a result, the heating range is expanded around the intended sealing portion, the temperature rise of the intended sealing portion is delayed, and the temperature rise of the intended sealing portion of the current introducing conductor is reduced. Hence, since the temperature difference increases between the ceramic in the intended sealing portion and the opposite portion of the current introducing conductor, fitting of the ceramic to the current introducing conductor becomes difficult, and cracks are likely to occur in the sealing portion and the pipe formed of translucent ceramic in the vicinity.

As long as the thermal conductivity difference is 5 W/m·K or more, the conductivity of the current introducing conductor can be sufficiently raised. Therefore, the thermal conductivity difference is preferably in the range of 5 to 75 W/m·K, more preferably 5 to 58 W/m·K.

When the translucent ceramic discharge vessel is formed of translucent alumina ceramic of which thermal conductivity is 34 W/m·K, the current introducing conductor is desired to have a larger thermal conductivity, smaller linear expansion coefficient difference than ceramic, as well as favorable sealing performance and oxidation resistance. A metal generally cannot satisfy these requirements. By contrast, the cermet is a mixed sinter of ceramic and metal, and depending on the blending ratio, a desired liner expansion factor can be obtained in a wide range. For example, the cermet of alumina ceramic and molybdenum blended by 50:50 by volume has about 78 to 98 W/m·K, and a linear expansion coefficient difference of 75 W/m·K can be realized with the translucent alumina ceramic (thermal conductivity of 34 W/m·K).

Therefore, the cermet is preferred at least as the material for the current introducing conductor in the intended sealing portion. When using a conductive metal such as molybdenum (Mo) or tungsten (W) as the current introducing conductor, it is preferred to employ a composite structure using cermet in the intended sealing portion. In this case, the current introducing conductor may be either stepped structure in the axial direction, stepped structure in peripheral direction, or stepless inclined structure.

The high-pressure discharge lamp of the second embodiment, for example, the metal halide lamp for an automobile headlight has a structure as shown in FIGS. 1 and 2.

Thus, according to the second embodiment, in the sealed structure of heating and fusing the intended sealing portion of the translucent ceramic discharge vessel and fusing to the current introducing conductor, by defining the thermal conductivity difference within 75 W/m·K between a portion of the pipe of the discharge vessel and a portion of the current introducing conductor, which are located the sealing portion, respectively, occurrence of cracks can be suppressed, and a high-pressure discharge lamp having the sealing portion of high reliability and high stability can be provided.

### Third Embodiment

A high-pressure discharge lamp according to a third embodiment is basically similar to that of the first embodiment, including a translucent ceramic discharge vessel, a current introducing conductor, electrodes and discharge medium. In this lamp, the current introducing conductor is inserted in the pipe of the translucent ceramic discharge vessel, and at least in the sealing portion formed by fusing the translucent ceramic in the pipe, the linear expansion coefficient difference between the pipe and the current introducing conductor is 4 ppm or less. That is, the linear expansion coefficient difference between a portion of the pipe and a portion of the current introducing conductor, which are located the sealing portion, respectively, is 4 ppm or less.

In the region close to the intended sealing portion of the pipe of the translucent ceramic discharge vessel, for the reasons explained above, the average crystal particle size is desired to be 50 μm or less, more preferably 30 μm or less. In particular, by setting the average crystal particle size at 1 μm or less, occurrence of cracks when bonding by fusing can be extremely reduced. Further, by defining the average crystal particle size at 0.5 μm or less, cracks when bonding by fusing can be avoided almost completely. Therefore, the average crystal particle size in the intended sealing portion of the pipe is desired to be 0.1 to 30 μm, more preferably 0.5 to 20 μm.

The linear expansion coefficient difference of 4 ppm means 4×10⁻⁶ (/K) or 4 (ppm/K). That is, when expressed by (/K) as a general unit of linear expansion coefficient, the value of molybdenum is 5.1×10⁻⁶ (/K), and the value of alumina is 8×10⁻⁶ (/K). The linear expansion coefficient difference of these materials is 2.9×10⁻⁶ (/K), and when it is expressed in the unit of ppm, it is 2.9 (ppm/K), which satisfies the condition of within 4 ppm. Hence, the material at least in the intended sealing portion of the current introducing conductor is desired to be cermet having a large content of alumina. If known sealing metal is used as the current introducing conductor, for example, a conductive metal such as molybdenum (Mo) or tungsten (W), it is preferred to build in a composite structure by using cermet in the intended sealing portion. In this case, the current introducing conductor may be either stepped structure in the axial direction, stepped structure in peripheral direction, or stepless inclined structure. Such specific current introducing conductor combined with cermet has an inclined function structure of 0.9 mm in diameter, having 80 wt % Mo-alumina cermet layer contacting airtightly with the circumference of Mo wire of 0.3 mm in diameter, and with the cermet layer provided sequentially in contact so that the outermost layer may be 40 wt % Mo-alumina cermet layer of 0.1 mm in thickness. This compounded current introducing conductor is inserted and sealed in the pipe of 1.0 mm in inside diameter in the translucent ceramic discharge vessel.

By defining the linear expansion coefficient difference at 4 ppm or less between the pipe of the translucent ceramic discharge vessel in the sealing portion and the current introducing conductor, stress at the time of sealing decreases, and occurrence of cracks can be obviously decreased. If the linear expansion coefficient difference is 1.87 ppm or less, cracks can be further reduced. If the linear expansion coefficient difference is 0.6 ppm or more, the current introducing conductor has a high conductivity. Hence, the linear expansion coefficient difference is desired to be somewhere between 0.6 to 4 ppm.

By contrast, if the linear expansion coefficient difference exceeds 4 ppm, excessive stress occurs by sealing, and consequently cracks may be caused by sealing, subsequent heating, or lamp lighting.

The high-pressure discharge lamp of the third embodiment, for example, the metal halide lamp for an automobile headlight has a structure as shown in FIGS. 1 and 2.

Thus, according to the third embodiment, by defining the linear expansion coefficient difference between a portion of the pipe and a portion of the current introducing conductor, which are located the sealing portion, respectively, at 4 ppm or less, stress at the time of sealing decreases, and occurrence of cracks can be effectively suppressed. As a result, a high-pressure discharge lamp having the sealing portion of high reliability and high stability can be provided.

### Fourth Embodiment

A high-pressure discharge lamp according to a fourth embodiment is basically similar to that of the first embodiment, including a translucent ceramic discharge vessel, a current introducing conductors electrodes and discharge medium. In this lamp, the current introducing conductor is inserted in the pipe of the translucent ceramic discharge vessel, and at least in the sealing portion formed by fusing the translucent ceramic in the pipe, the thermal conductivity difference between a portion of the pipe and a portion of the current introducing conductor, which are located the sealing portion, respectively, is 75 W/m·K or less, and the linear expansion coefficient difference between a portion of the pipe and a portion of the current introducing conductor, which are located the sealing portion, respectively, is 4 ppm or less.

Thus, according to the fourth embodiment, in the sealing structure formed by heating and fusing the intended sealing portion of the translucent ceramic discharge vessel, and attaching to the current introducing conductor, occurrence of cracks can be evidently decreased, and a high-pressure discharge lamp having the sealing portion of higher reliability and higher stability can be provided.

### Fifth Embodiment

A high-pressure discharge lamp according to a fifth embodiment is basically similar to that of the first embodiment, including a translucent ceramic discharge vessel, a current introducing conductor, electrodes and discharge medium. In this lamp, the current introducing conductor is inserted in the pipe of the translucent ceramic discharge vessel, and at least the ratio S_{W}/S_{T} is in the range of 0.037 to 0.363, preferably 0.05 to 0.33 where S_{W} is the sectional area of the current introducing conductor, and S_{T} is the sectional area of the pipe positioned close to the sealing portion formed by fusing the translucent ceramic in the pipe.

The region close to the intended sealing portion of the pipe of the translucent ceramic discharge vessel is desired to have average crystal particle size of 50 μm or less, preferably 30 μm or less for the reasons explained above. In particular, when the average crystal particle size is 1 μm or less, occurrence of cracks when bonding by fusing can be extremely decreased. Further, by defining the average crystal particle size at 0.5 μm or less, cracks when bonding by fusing can be avoided almost completely. Therefore, the average crystal particle size in the region close to the intended sealing portion of the pipe is desired to be 0.1 to 30 μm, more preferably 0.5 to 20 μm.

The sectional area of the current introducing conductor having the ratio S_{W}/S_{T} defined in the range of 0.037 to 0.363 is smaller than the sectional area of the current introducing conductor in the conventional sealed structure using the frit glass. Accordingly, even if there is a difference in thermal expansion factor between the ceramic of the pipe and the current introducing conductor, stress occurring because of the difference is reduced, and cracks can be suppressed. If the current introducing conductor is too thin, the current passing resistance of the current introducing conductor may be too large to be ignored, and power loss due to heat generation may occur.

When the sectional areas of the pipe of the translucent ceramic discharge vessel and of the current introducing conductor satisfy the specified ratio S_{W}/S_{T}, the current introducing conductor is desired to have the diameter as defined below.

1. In the case of rated lamp power of 800 W or less, the diameter of the current introducing conductor is 2.5 mm or less, preferably 1.8 mm or less.

2. In the case of rated lamp power of 400 W or less, the diameter of the current introducing conductor is 1.5 mm or less, preferably 1.2 mm or less.

3. In the case of rated lamp power of 10 W or less, the diameter of the current introducing conductor is 0.5 mm or less, preferably 0.5 mm or less.

The high-pressure discharge lamp in the fifth embodiment, for example, the metal halide lamp for an automobile headlight has a structure as shown in FIGS. 1 and 2.

Thus, according to the fifth embodiment, in the sealing structure formed by heating and fusing the intended sealing portion of the translucent ceramic discharge vessel, and attaching to the current introducing conductor, by defining the ratio S_{W}/S_{T} in the range of 0.037 to 0.363 where S_{W} is the sectional area of the current introducing conductor and S_{T} is the sectional area of the pipe positioned close to the sealing portion of the discharge vessel, occurrence of cracks of ceramic in the sealing portion can be suppressed, and a high-pressure discharge lamp of high reliability and high stability can be provided.

### Sixth Embodiment

A high-pressure discharge lamp according to a sixth embodiment is basically similar to that of the first embodiment, including a translucent ceramic discharge vessel, a current introducing conductor, electrodes and discharge medium. In this lamp, the current introducing conductor is inserted in the pipe of the translucent ceramic discharge vessel, at least the sealing portion is formed by fusing translucent ceramic in the pipe, the ratio φ_{S}/φ_{T} is 1 to 2, and the ratio L_{S}/φ_{T} is 1 to 3, where φ_{S} is the maximum outside diameter of the sealing portion, L₅ is the length of the sealing portion, and φ_{T} is the outside diameter of the pipe close to the sealing portion.

By thus defining the ratio φ_{S}/φ_{T} and the ratio L_{S}/φ_{T} relating to the sealing portion, occurrence of cracks of ceramic in the pipe at the time of sealing can be suppressed.

The size of the sealing portion varies depending on the diameter and thickness of the pipe, heating time of sealing, heating region, heating means, or heating method. Therefore, to form the sealing portion so that the ratio φ_{S}/φ_{T} and the ratio L_{S}/φ_{T} may satisfy the specified range, the pipe and the current introducing conductor inserted in the pipe may be fused and sealed by properly selecting these parameters. For example, by laser emission, the intended sealing portion is locally heated, the laser and the translucent ceramic discharge vessel are relatively rotated by rotating the translucent ceramic discharge vessel preferably at 10 to 500 rpm, more preferably 100 to 300 rpm, and the laser output is controlled, thereby fusing the ceramic in the intended sealing portion.

By defining the ratio φ_{S}/φ_{T} and ratio L_{S}/φ_{T} in the range of 1 to 2, and 1 to 3, respectively, a sealing portion capable of lighting is obtained. If, however, the ratio φ_{S}/φ_{T} and ratio L_{S}/φ_{T} are out of the specified range, a sealing portion capable of lighting is not obtained. In this heating and sealing process, when relatively rotating the laser and the translucent ceramic discharge vessel, if the rotating speed is too fast, the sealing portion is too short, the ratio L_{S}/φ_{T} is out of the lower limit, and cracks are likely to be formed in the sealing portion.

The high-pressure discharge lamp in the sixth embodiment, for example, the metal halide lamp for an automobile headlight has a structure as shown in FIGS. 1 and 2.

Thus, according to the sixth embodiment, by defining the ratio φ_{S}/φ_{T} in the range of 1 to 2, and the ratio L_{S}/φ_{T} in the range of 1 to 3, where φ_{S} is the maximum outside diameter of the sealing portion, L_{S} is the length of the sealing portion, and φ_{T} is the outside diameter of the pipe close to the sealing portion, stress in sealing is decreased, occurrence of cracks can be suppressed effectively, and a high-pressure discharge lamp of high reliability and high stability can be provided.

### Seventh Embodiment

A high-pressure discharge lamp operating apparatus according to a seventh embodiment includes the high-pressure discharge lamp in any one of the foregoing first to sixth embodiments, and a lighting circuit for lighting the high-pressure discharge lamp.

The lighting circuit is not particularly specified in structure. The lighting circuit may be of either alternating-current lighting type or direct-current lighting type. In the case of the alternating-current lighting type, for example, an electronic lighting circuit including an inverter may be composed. A DC-DC converting circuit such as boosting chopper or step-down chopper may be added to a direct-current power source connected between input terminals of the inverter. In the case of the direct-current lighting type, for example, an electronic lighting circuit may be composed by mainly including the DC-DC converting circuit.

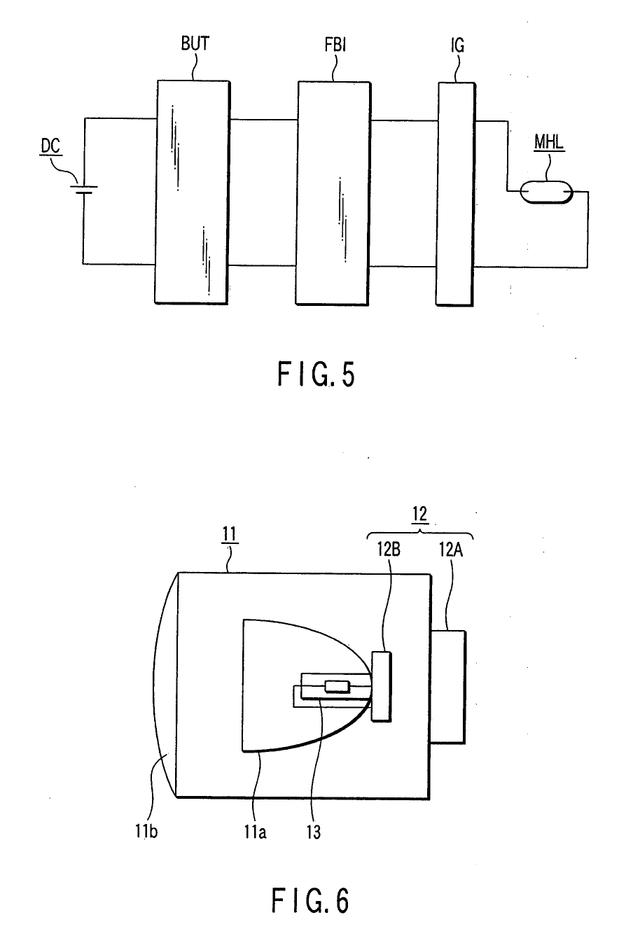

The high-pressure discharge lamp operating apparatus in the seventh embodiment will be specifically explained by referring to FIG. 5. FIG. 5 is a block diagram of the high-pressure discharge lamp operating apparatus.

The lighting circuit is, for example, a low-frequency alternating-current lighting circuit type, and is electronic. The lighting circuit includes a direct-current power source DC, a boosting chopper BUT, a full bridge inverter FBI, and an igniter IG, and is designed to light up a metal halide lamp MHL for an automobile headlight.

The direct-current power source DC is, for example, a vehicle battery. The boosting chopper BUT has its input terminal connected to the direct-current power source DC. The full bridge inverter FBI has its input terminal connected to the output terminal of the boosting chopper BUT. The igniter IG receives the low-frequency alternating-current output from the full bridge inverter FBI, generates a high-voltage starting pulse, and applies the pulse between a pair of electrodes of the metal halide lamp MHL for automobile headlight described below when starting up.

The metal halide lamp MHL for automobile headlight may be properly selected from the high-pressure discharge lamps in the foregoing first to sixth embodiments as desired, and is connected between output terminals of the full bridge inverter FBI to light up in low-frequency alternating-current lighting operation.

### Eighth Embodiment

An illuminating apparatus according to an eighth embodiment includes an illuminating apparatus main body, the high-pressure discharge lamp in any one of the foregoing first to sixth embodiments, and a lighting circuit for lighting the high-pressure discharge lamp.

The illuminating apparatus main body is the remaining portion of the illuminating apparatus excluding the high-pressure discharge lamp and lighting circuit.

The lighting circuit may be disposed at a position apart from the illuminating apparatus main body.

The illuminating apparatus in the eighth embodiment includes all apparatuses using the high-pressure discharge lamp as a light source. Examples thereof include indoor and outdoor lighting devices, automobile headlights, image and video projectors, marking lamps, signal lights, display lamps, chemical reaction apparatus, and inspection instrument.

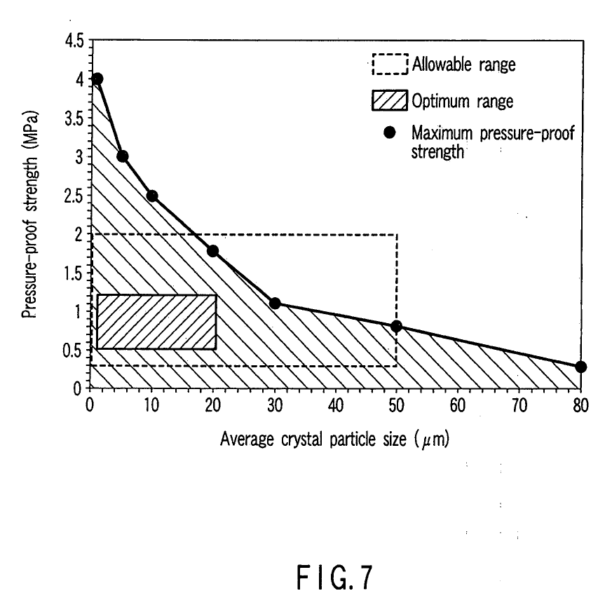

The illuminating apparatus in the eighth embodiment will be specifically explained by referring to FIG. 6. FIG. 6 is a side view of an automobile headlight as an Example of the illuminating apparatus.

In FIG. 6, reference numeral 11 is a headlight main body, 12 is a high-pressure discharge lamp operating apparatus, and 13 is a metal halide lamp for an automobile headlight.

The headlight main body 11 is formed like a container, which incorporates a reflector 11a in the inside, and a lens 11b and a lamp socket (not shown) at the front side.

The high-pressure discharge lamp operating apparatus 12 has the same circuit structure as shown in FIG. 5, and includes a main lighting circuit 12A and a starter 12B. The main lighting circuit 12A mainly includes the boosting chopper BUT and full bridge inverter FBI shown in FIG. 5. The starter 12B mainly includes the igniter IG shown in FIG. 5.

The metal halide lamp for the automobile headlight 13 is installed in the lamp socket to light up.

Examples of the invention will be described below.

### Example 1

The high-pressure discharge lamp includes members specified in the following dimensions and materials, and has the structure as shown in FIGS. 1 and 2.

Translucent ceramic discharge vessel: formed of translucent polycrystal alumina ceramic of integral forming type
Surrounding part: maximum outside diameter 6 mm, maximum inside diameter 5 mm, wall thickness 0.5 mm
Pipe: outside diameter 2.7 mm, inside diameter 0.7 mm, length 5 mm, average crystal particle size 30 μm

Current introducing conductor: Mo—Al₂O₃=50:50 vol % cermet bar, diameter 0.65 mm

Electrode: distance between electrodes 3 mm

Discharge medium: DyI₃—NdI₃—CsI=3 mg, Xe, sealing pressure 0.5 MPa

Rated lamp power: 35 W

### Comparative Example 1

The high-pressure discharge lamp is similar in specification to Example 1 and has the structure as shown in FIGS. 1 and 2, except for members specified in the following dimensions and materials.

Translucent ceramic discharge vessel: formed of translucent polycrystal alumina ceramic of integral forming type
Surrounding part: maximum outside diameter 6 mm, maximum inside diameter 5 mm, wall thickness 0.5 mm
Pipe: outside diameter 2.7 mm, inside diameter 0.7 mm, length 12 mm, average crystal particle size 70 μm

Current introducing conductor: Nb bar, diameter 0.65 mm

### Example 2

The high-pressure discharge lamp is similar in specification to Example 1 and has the structure as shown in FIG. 4A, except for members specified in the following dimensions and materials.

Translucent ceramic discharge vessel: formed of translucent alumina ceramic of two-body forming type
Surrounding part: polycrystal alumina ceramic of linear transmissivity 40%, maximum outside diameter 6 mm, maximum inside diameter 5 mm, wall thickness 0.5 mm
Pipe: alumina ceramic, outside diameter 1.7 mm, inside diameter 0.7 mm, length 5 mm, average crystal particle size 1 μm

Current introducing conductor: cermet (Mo—Al₂O₃=1:1 by volume) bar, diameter 0.65 mm

### Example 3

The high-pressure discharge lamp is similar in specification to Example 1 and has the structure as shown in FIG. 4B, except for members specified in the following dimensions and materials.

Translucent ceramic discharge vessel: formed of translucent alumina ceramic of two-body forming type
Surrounding part: polycrystal alumina ceramic of linear transmissivity 40%, maximum outside diameter 6 mm, maximum inside diameter 5 mm, wall thickness 0.5 mm
Pipe: alumina ceramic, outside diameter 1.7 mm, inside diameter 0.7 mm, length 5 mm, average crystal particle size 1 μm

Current introducing conductor: cermet (Mo—Al₂O₃=1:1 by volume) bar, diameter 0.65 mm

### Comparative Example 2

The high-pressure discharge lamp is similar in specification to Example 1 and has the structure as shown in FIGS. 1 and 2, except for members specified in the following dimensions and materials.

Translucent ceramic discharge vessel: formed of translucent polycrystal alumina ceramic of integral forming type
Surrounding part; maximum outside diameter 6 mm, maximum inside diameter 5 mm, wall thickness 0.5 mm, linear transmissivity 19%
Pipe: outside diameter 1.7 mm, inside diameter 0.7 mm, length 12 mm, average crystal particle size 70 μm

Current introducing conductor: Nb bar, diameter 0.65 mm

FIG. 7 is a graph showing relation between average crystal particle size and pressure-proof strength in the closet region of the intended sealing portion of the translucent ceramic discharge vessel in the high-pressure discharge lamp. In FIG. 7, the abscissa represents the average crystal particle size (μm) and the ordinate represents the pressure-proof strength (Pa).

As can be known from FIG. 7, by defining the average crystal particle size in the closet region of the intended sealing portion of the pipe at 50 μm or less as in Examples 1 to 3, a maximum pressure-proof strength of 0.8 MPa or more is obtained. In particular, as in Example 1, when the average crystal particle size in the closet region of the intended sealing portion of the pipe is 30 μm or less, a maximum pressure-proof strength of 1.1 MPa or more is obtained. Also, as in Examples 2 and 3, when the average crystal particle size in the closet region of the intended sealing portion of the pipe is 10 μm or less, a maximum pressure-proof strength of 2.5 MPa or more is obtained.

By contrast, as in Comparative Examples 1 and 2, when the average crystal particle size in the closet region of the intended sealing portion of the pipe exceeds 50 μm, for example, 70 μm, a maximum pressure-proof strength is only about 0.5 MPa.

Therefore, as in Examples 1 to 3, when the average crystal particle size in the closet region of the intended sealing portion of the pipe is 50 μm or less, the sealing pressure is in the range of 0.3 to 2.0 MPa, and when the average crystal particle size is 0.5 to 20 μm, the sealing pressure is in an optimum range of 0.5 to 1.2 MPa.

### Example 4

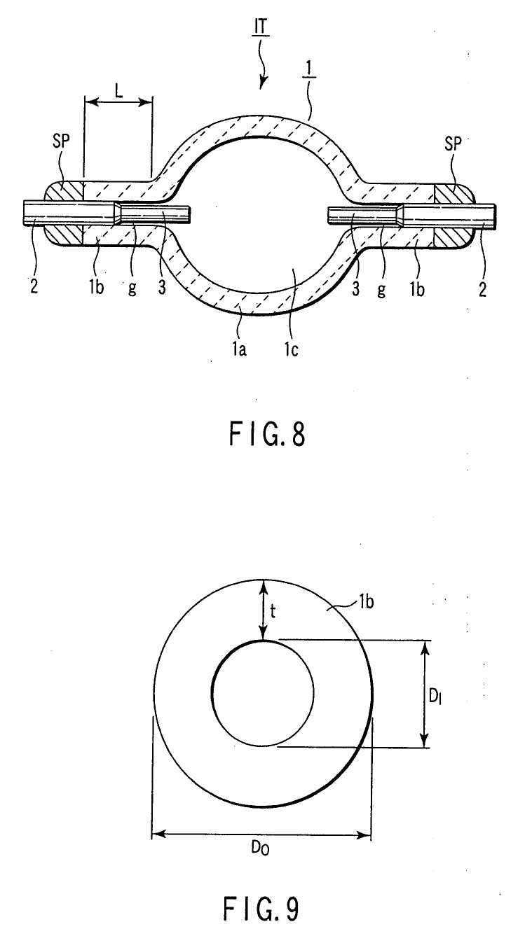

The high-pressure discharge lamp includes members specified in the following dimensions and materials, and has the structure as shown in FIGS. 8 and 9. In FIGS. 8 and 9, effective length L of pipe 1b is the length of the portion excluding the sealing portion SP from the length of the pipe 1b, that is, the length of the portion containing the discharge medium possibly staying inside. The outside diameter D_{O} of the pipe 1b is the outside diameter at the position closest to the sealing portion SP of the pipe 1b. The inside diameter D_{I} of the pipe 1b is the inside diameter at the position closest to the sealing portion SP, and t is the thickness of the pipe i.e. wall thickness at the position closest to the sealing portion SP.

Translucent ceramic discharge vessel: formed of translucent polycrystal alumina ceramic of integral forming type, average crystal particle size of entire vessel 10 μm
Surrounding part: maximum outside diameter 6 mm, maximum inside diameter 5 mm, wall thickness 0.5 mm,
Pipe: outside diameter (D_{O}) 1.5 mm, inside diameter (D_{I}) 0.7 mm, wall thickness (t) 0.4 mm, effective length (L) 0.75 mm, L/D_{O}=0.5, D_{I}/t=1.75

Current introducing conductor: Mo—Al₂O₃=50:50 vol % cermet bar, diameter 0.65 mm

Electrode: distance between electrodes 3 mm

Discharge medium: DyI₃—NdI₃—CsI=3 mg, Xe, sealing pressure 1 MPa

Rated lamp power: 35 W

### Example 5

The high-pressure discharge lamp is similar in specification to Example 4 and has the structure as shown in FIGS. 1 and 2, except for members specified in the following dimensions and materials.

Translucent ceramic discharge vessel: formed of translucent polycrystal alumina ceramic of integral forming type, average crystal particle size of entire vessel 10 μm
Surrounding part: maximum outside diameter 6 mm, maximum inside diameter 5 mm, wall thickness 0.5 mm
Pipe: outside diameter (D_{O}) 1.5 mm, inside diameter (D_{I}) 0.7 mm, wall thickness (t) 0.4 mm, effective length (L) 1.5 mm, L/D_{O}=1.0, D_{I}/t=1.75

### Example 6

The high-pressure discharge lamp is similar in specification to Example 4 and has the structure as shown in FIGS. 1 and 2, except for members specified in the following dimensions and materials.

Translucent ceramic discharge vessel: formed of translucent polycrystal alumina ceramic of integral forming type, average crystal particle size of entire vessel 10 μm
Surrounding part: maximum outside diameter 6 mm, maximum inside diameter 5 mm, wall thickness 0.5 mm
Tube: outside diameter (D_{O}) 1.5 mm, inside diameter (D_{I}) 0.7 mm, wall thickness (t) 0.4 mm, effective length (L) 4.5 mm, L/D_{O}=3.0, D_{I}/t=1.75

### Example 7

The high-pressure discharge lamp is similar in specification to Example 4 and has the structure as shown in FIGS. 1 and 2, except for members specified in the following dimensions and materials.

Translucent ceramic discharge vessel: formed of translucent polycrystal alumina ceramic of integral forming type, average crystal particle size of entire vessel 10 μm
Surrounding part: maximum outside diameter 6 mm, maximum Inside diameter 5 mm, wall thickness 0.5 mm
Pipe: outside diameter (D_{O}) 2.0 mm, inside diameter (DT) 1.0 mm, wall thickness (t) 0.5 mm, effective length (L) 6.0 mm, L/D_{O}=3.0, D_{I}/t=2.0

### Comparative Example 3

The high-pressure discharge lamp is similar in specification to Example 4 and has the structure as shown in FIGS. 1 and 2, except for members specified in the following dimensions and materials.

Translucent ceramic discharge vessel: formed of translucent polycrystal alumina ceramic of integral forming type, average crystal particle size of entire vessel 70 μm
Surrounding part: maximum outside diameter 6 mm, maximum inside diameter 5 mm, wall thickness 0.5 mm
Pipe: outside diameter (D_{O}) 1.5 mm, inside diameter (D₁) 0.7 mm, wall thickness (t) 0.4 mm, effective length (L) 12 mm, L/D_{O}=8.0, D_{I}/t=1.75

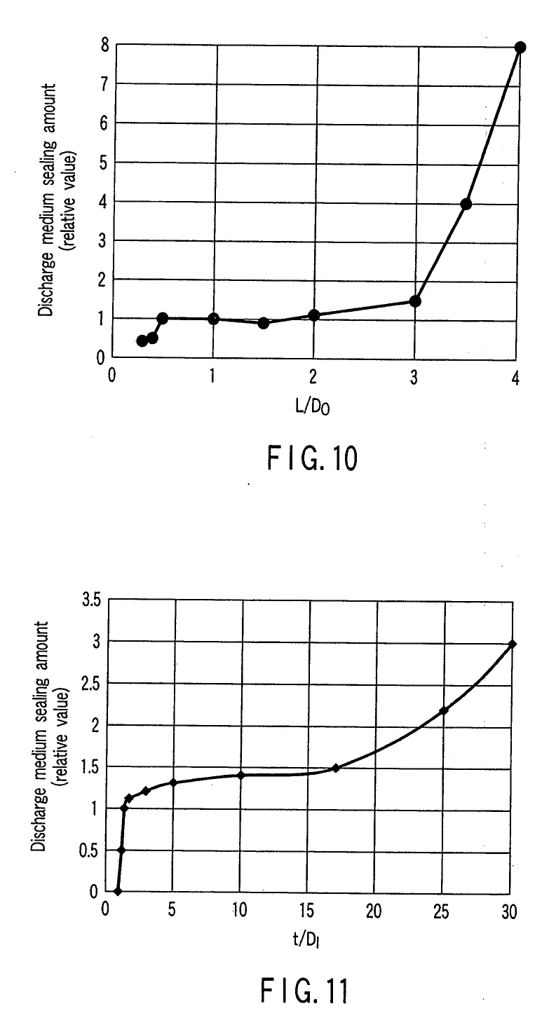

FIG. 10 is a graph showing relation between ratio L/D_{O} of pipe outside diameter D_{O} to pipe effective length L, and sealing amount of discharge medium. In FIG. 10, the abscissa represents the ratio L/D_{O} and the ordinate represents the sealing amount (relative value) of the discharge medium.

As can be known from FIG. 10, by defining the ratio L/D_{O} in the range of 0.5 to 3.0 as in Examples 4 to 7, the sealing amount of the discharge medium can be decreased relatively. By contrast, as in Comparative Example 3, when the ratio L/D_{O} exceeds 3.0, the sealing amount of the discharge medium is increased suddenly.

FIG. 11 is a graph showing relation between the ratio D_{I}/t of the inside diameter D_{I} of the pipe of the translucent ceramic discharge vessel to the wall thickness t of the pipe in the high-pressure discharge lamp, and the sealing amount of the discharge medium. In FIG. 11, the abscissa represents the ratio D_{I}/t and the ordinate represents the sealing amount (relative value) of discharge medium.

As can be known from FIG. 11, by defining the ratio D_{I}/t in the range of 1.4 to 17 as in Examples 4 to 7, the sealing amount of the discharge medium can be decreased relatively.

### Example 8

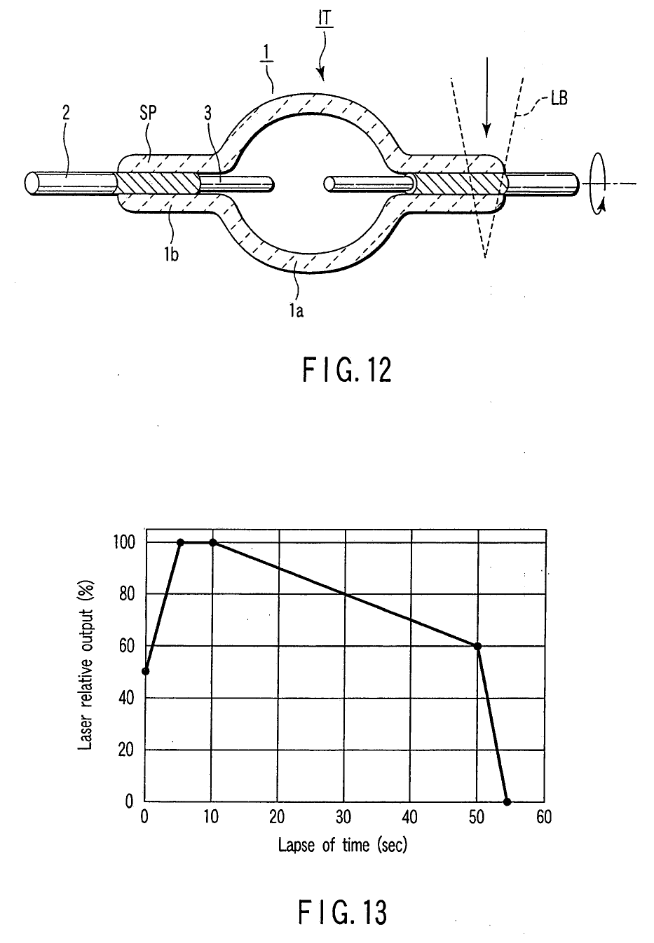

FIG. 12 is a sectional view showing manufacture of is the translucent ceramic discharge vessel of the high-pressure discharge lamp in Example 8, and FIG. 13 is a graph showing relation between passing time and laser relative output in heating process of the intended sealing portion by laser emission.

The translucent ceramic discharge vessel 1 and the current introducing conductor 2 are rotated in a direction of right side arrow in the diagram with respect to the YAG laser beam LB, and the laser is emitted in a downward arrow direction in the diagram, to form the sealing portion SP. The laser emission output is controlled as specified with the passing of the time as shown in FIG. 13. The current introducing conductor 2 is a cermet bar.

Supposing the laser output to be 100% in relative value, the laser output is increased gradually until the intended sealing portion of the pipe 1b is fused, and when reaching the output 100%, the level of 100% is maintained for a while, for example, for several seconds, and the ceramic are fused sufficiently. Later, when the ceramic are sufficiently wet and fit into the current introducing conductor 2, the laser output is gradually reduced from 100% to 0%. The laser beam is emitted by deviating its focal point slightly behind from the heating position.

By thus emitting the laser to the intended sealing portion while controlling the laser output, a favorable sealing portion SP free from cracks or bubbles in sealing process can be obtained.

### Example 9

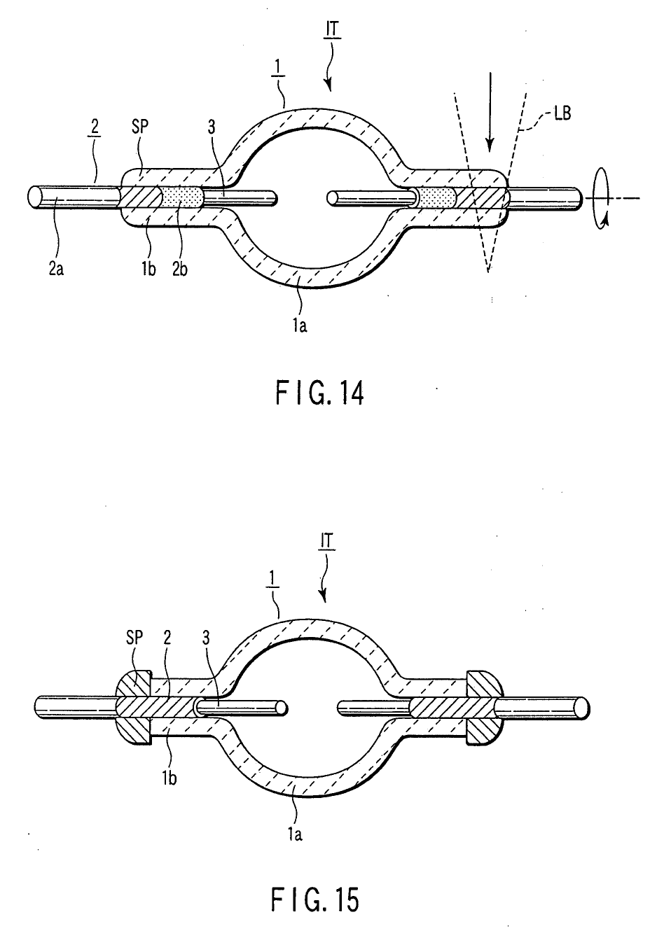

FIG. 14 is a sectional view showing manufacture of the translucent ceramic discharge vessel of the high-pressure discharge lamp in Example 9.

This is the same as Example 8, except that the current introducing conductor 2 is a bonded structure of a cermet bar 2a and an Mo bar 2b bonded in the axial direction, and that the portion of the cermet bar 2a is sealed.

### Example 10

FIG. 15 is a sectional view showing manufacture of the translucent ceramic discharge vessel of the high-pressure discharge lamp in Example 10.

In Example 10, the sealing portion SP is bulged in a direction orthogonal to the axis, and is formed in an irregular shape. This is mainly because it is contracted in the axial direction by surface tension when the ceramic of the pipe 1b is fused in the intended sealing portion. The sealing portion SP often forms a solid solution structure by solid solution of components of the current introducing conductor 2 in the ceramic. In this case, this portion has a color different from the natural color of the ceramic.

### Example 11

The translucent ceramic discharge vessel 1 having the surrounding part 1a and the pipe 1b shown in FIGS. 1 and 2 is formed of translucent polycrystal alumina ceramic, and has the thermal conductivity of 34 W/m·K. The current introducing conductor 2 shown in the drawing is formed of cermet of alumina and molybdenum at ratio of 50:50 by volume, and has the thermal conductivity of about 78 to 98 W/m·K. In Example 11, therefore, the difference in thermal conductivity between the pipe 1b and the current introducing conductor 2, which are located the sealing portion, respectively, is 44 to 64 W/m·K.

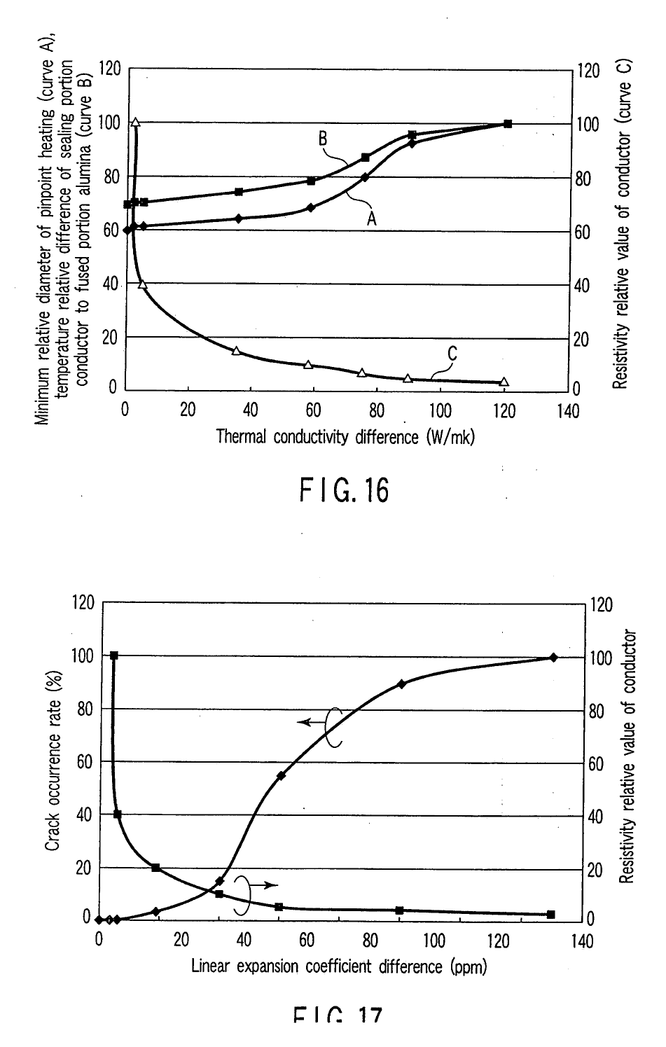

FIG. 16 is a graph showing relation among difference in thermal conductivity between the pipe of the translucent ceramic discharge vessel and the current introducing conductor, the minimum diameter that can be heated, the temperature difference between the ceramic fused portion and the confronting current introducing conductor position, and the resistance of the current introducing conductor. In FIG. 16, the abscissa represents the thermal conductivity difference (W/m·K), the left side of the ordinate represents the minimum relative diameter of pinpoint heating showing the minimum diameter that can be heated (curve A), and the temperature difference relative value of the sealing portion conductor relative to the fused portion alumina showing the temperature difference between the ceramic fused portion and the confronting current introducing conductor position (curve B), and the right side shows the resistivity relative value of the conductor showing the resistance of the current introducing conductor (curve C).

As can be known from FIG. 16, when the thermal conductivity difference is 75 W/m·K or less as in Example 11, the minimum diameter of heating portion that can be heated so as to be sealed can be decreased, that is, the sealing portion can be minimized, the temperature difference is decreased between the ceramic of the intended sealing portion and the current introducing conductor, and the both can be fitted sufficiently. The current introducing conductor shows a favorable conductivity.

### Example 12

The translucent ceramic discharge vessel 1 having the surrounding part 1a and the pipe 1b shown in FIGS. 1 and 2 is formed of translucent polycrystal alumina ceramic, and has the linear expansion coefficient of about 6.8 to 7.4 ppm. The current introducing conductor 2 shown in the drawing is formed of cermet of alumina and molybdenum at ratio of 40:60 by volume, and has the linear expansion coefficient of about 6.8 to 7.4 ppm. In Example 12, therefore, the difference in linear expansion coefficient between the pipe 1b and the current introducing conductor 2, which are located the sealing portion, respectively, is 0.6 to 1.2 ppm.

### Example 13

The translucent ceramic discharge vessel 1 having the surrounding part 1a and the pipe 1b shown in FIGS. 1 and 2 is formed of translucent polycrystal alumina ceramic, and has the linear expansion coefficient of about 6.8 to 7.4 ppm. The current introducing conductor 2 shown in the drawing is a niobium bar, and its linear expansion coefficient is 7.2 ppm. In Example 13, therefore, the difference in linear expansion coefficient between the pipe 1b and the current introducing conductor 2, which are located the sealing portion, respectively, is 0.8 ppm.

FIG. 17 is a graph showing relation among the difference in linear expansion coefficient between the pipe and the current introducing conductor, which are located the sealing portion, respectively, the crack occurrence rate due to sealing, and the resistance of the current introducing conductor. In FIG. 17, the abscissa represents the linear expansion coefficient (ppm), the left side of the ordinate represents the crack occurrence rate (%) due to sealing, and the right side shows the resistivity relative value of the current introducing conductor. The crack occurrence rate was calculated by counting the number of cracks occurring in 100 hours after the start of sealing.

As can be known from FIG. 17, if the linear expansion difference is 4 ppm or less as in Examples 12 and 13, the crack occurrence rate in 100 hours of lighting from the start of sealing can be substantially decreased.

### Example 14

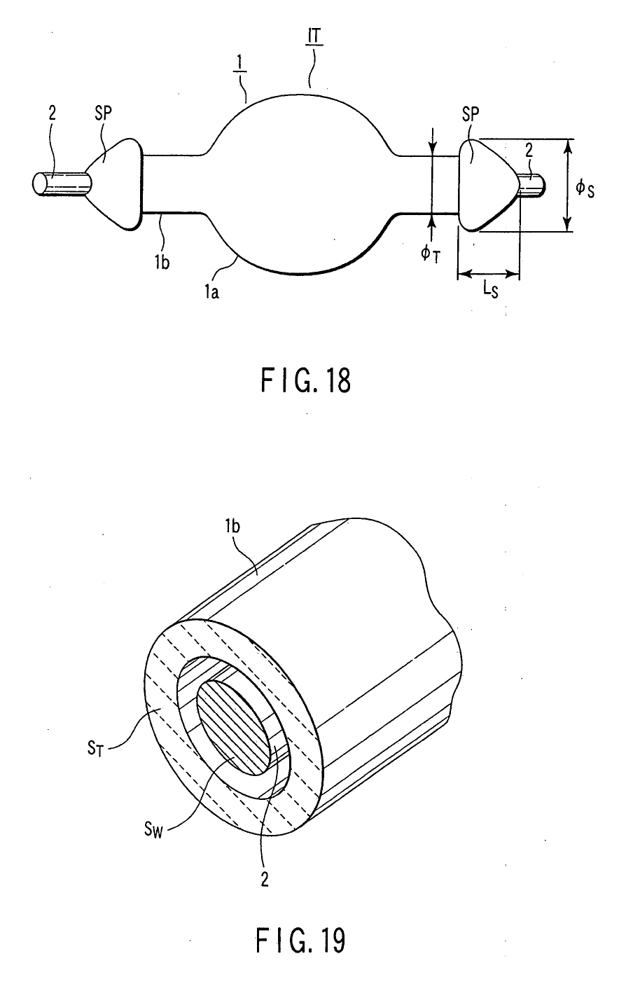

The high-pressure discharge lamp includes members specified in the following dimensions and materials, and has the structure as shown in FIGS. 18 and 19. In FIG. 18, φ_{S} shows the maximum outside diameter of the sealing portion SP, L_{S} is the length of the sealing portion SP, and φ_{T} is the outside diameter of the pipe 1b of the translucent ceramic discharge vessel positioned closely to the sealing portion SP. In FIG. 19, S_{T} shows the sectional area of the pipe positioned closely to the sealing portion of the translucent ceramic discharge vessel, and S_{W} shows the sectional area of the current introducing conductor positioned closely to the sealing portion.

Translucent ceramic discharge vessel: formed of translucent polycrystal alumina ceramic of integral forming type
Surrounding part: maximum outside diameter 6 mm, maximum inside diameter 5 mm, wall thickness 0.5 mm
Pipe: outside diameter 2.7 mm (φ_{T}), inside diameter 0.7 mm, length 5 mm, sectional area ratio S_{T} 5.34 mm²

Current introducing conductor: Mo—Al₂O₃ 50:50 vol % cermet bar, diameter 0.65 mm, sectional area ratio S_{W} 0.33 mm², sectional area ratio S_{W}/S_{T} 0.062

Sealing portion: maximum outside diameter φ_{S} 3.5 mm, length L_{S} 3.2 mm, ratio φ_{S}/φ_{T} 1.3, ratio L_{S}/φ_{T} 1.2

Electrode: distance between electrodes 3 mm

Discharge medium: DyI₃—NdI₃—CsI—ZnI₂=3 mg, Xe: 0.5 atmospheric pressure

Rated lamp power: 35 W

### Example 15

The high-pressure discharge lamp is similar in specification to Example 14 and has the structure as shown in FIGS. 18 and 19, except for members specified in the following dimensions and materials.

Translucent ceramic discharge vessel: formed of translucent polycrystal alumina ceramic of integral forming type
Surrounding part: maximum outside diameter 6 mm, maximum inside diameter 5 mm, wall thickness 0.5 mm
Pipe: outside diameter 1.7 mm (φ_{T}), inside diameter 0.4 mm, length 5 mm, sectional area ratio S_{T} 0.096 mm²

Current introducing conductor: Mo—Al₂O₃ 50:50 vol % cermet bar, diameter 0.35 mm, sectional area ratio S_{W} 2.01 mm², sectional area ratio S_{W}/S_{T} 0.047

Sealing portion: maximum outside diameter φ_{S} 2.6 mm, length L_{S} 2.7 mm, ratio φ_{S}/φ_{T} 1.7, ratio L_{S}/φ_{T} 1.6

Electrode: distance between electrodes 3 mm

Discharge medium: DyI₃—NdI₃—CsI—ZnI₂=3 mg, Xe: 6 atmospheric pressure

Rated lamp power: 35 W

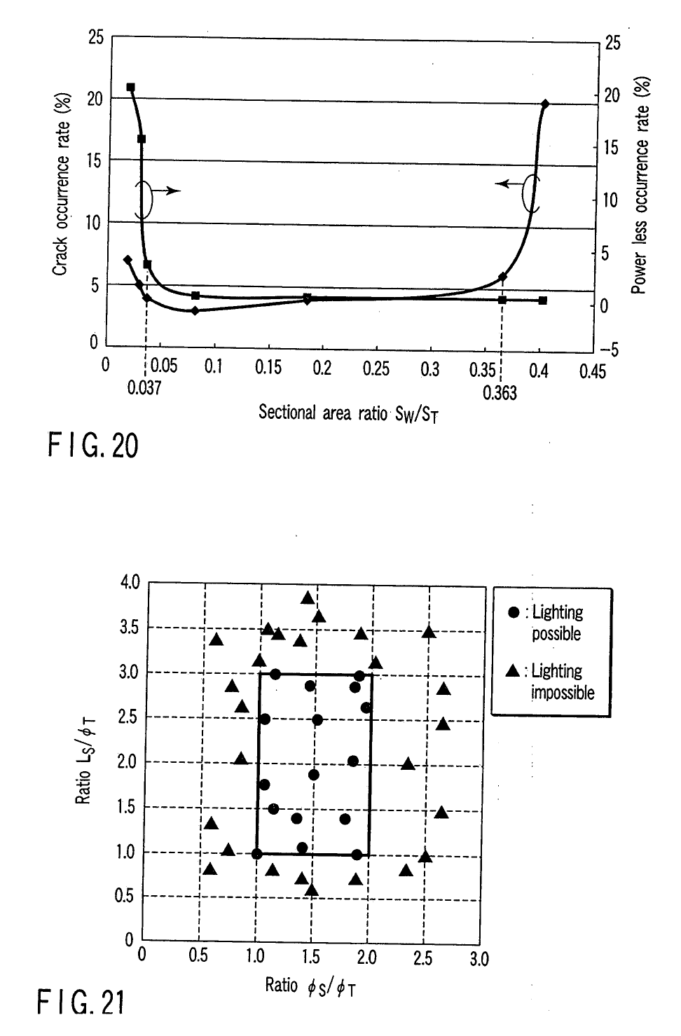

FIG. 20 is a graph showing relation among sectional area ratio S_{W}/S_{T} where S_{T} is the sectional area of the pipe positioned closely to the sealing portion of the translucent ceramic discharge vessel in the high-pressure discharge lamp and S_{W} is the sectional area of the current introducing conductor positioned closely to the sealing portion, the crack occurrence rate, and the power loss occurrence rate. In FIG. 20, the abscissa represents the sectional area ratio S_{W}/S_{T}, the left side of the ordinate represents the crack occurrence rate, and the right side represents the power loss occurrence rate %. Herein, the power loss refers to the power loss occurring by heat generation of 1% or more of lamp power, because of a small sectional area of the conductive portion of the current introducing conductor. Hence, the power loss occurrence rate is the percentage of occurrence of significant power generation failure caused by an extremely thin current introducing conductor.

As can be understood from FIG. 20, by defining the sectional area ratio S_{W}/S_{T} in the closet region of the sealing portion of the pipe and the current introducing conductor in the range of 0.037 to 0.363, both crack occurrence rate and power loss occurrence rate can be substantially decreased.

By increasing a diameter of the pipe, the lamp performance can be improved, but realistically the pipe diameter cannot be too large. If the pipe diameter is too large, heat loss occurs, which may lead to decline of efficiency, or the amount of impurity increases because of an increase in the total amount of discharge medium. As a result, the starting characteristic may be defective, the service life is shortened, and characteristic instability factors are increased. Assuming that the pipe should not be increased in diameter, the small abscissa in FIG. 20 (the sectional area ratio S_{W}/S_{T}) means a small sectional area of the current introducing conductor. As compared with the rated current of each lamp type, when the sectional area of the current introducing conductor becomes smaller than a specific range, the resistance heat generation by this conductor evidently elevates the temperature of the conductor. Along with this temperature rise, the resistivity of the conductor increases suddenly. At this time, the current does not change significantly, and thus the resistance heat generation further increases, thereby elevating the conductor temperature even higher. As a result of such chain reaction, heat is generated relatively suddenly below a specific sectional area ratio Sw/S_{T}, and the power loss occurs significantly.

FIG. 21 is a graph of lighting test results of high-pressure discharge lamps manufactured by varying the maximum outside diameter φ_{S} of the sealing portion SP shown in FIG. 18, length L_{S} of the sealing portion SP, and outside diameter φ_{T} of the pipe 1b positioned closer to the sealing portion SP. In FIG. 21, the abscissa represents the ratio φ_{S}/φ_{T}, and the ordinate represents the ratio L_{S}/φ_{T}.

As can be known from FIG. 21, by defining the ratio φ_{S}/φ_{T} in the range of 1 to 2 and the ratio L_{S}/φ_{T} in the range of 1 to 3 as in Examples 14 and 15, sealing is preferable and lighting is possible, but if out of the above specified ranges, lighting becomes impossible.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A high-pressure discharge lamp comprising:
a translucent ceramic discharge vessel having a surrounding part formed of translucent ceramic, and a pipe connected to the surrounding part, formed of translucent ceramic having an average crystal particle size of 50 μm or less in a region close to an intended sealing portion, and having a smaller diameter than the surrounding part;
a current introducing conductor inserted into the pipe of the translucent ceramic discharge vessel, and sealed at least by a sealing portion formed by fusion of the translucent ceramic in the pipe;
an electrode connected to and disposed in the current introducing conductor in the translucent ceramic discharge vessel; and
a discharge medium sealed in the translucent ceramic discharge vessel.

2. The high-pressure discharge lamp according to claim 1, wherein the pipe has an average crystal particle size of 0.5 to 4 μm in the closest region of the intended sealing portion.

3. The high-pressure discharge lamp according to claim 1, wherein the sealing portion formed by fusion of the translucent ceramic in the pipe has an average crystal particle size larger than that of a non-sealing portion in the pipe.

4. The high-pressure discharge lamp according to claim 1, wherein the pipe has a length of 19 mm or less when a rated lamp power is 800 W or less, or a length of 7 mm or less when the rated lamp power is 100 W or less.

5. The high-pressure discharge lamp according to claim 1, wherein the translucent ceramic discharge vessel is 0.5 to 3.0 in a ratio L/D_{O} of an effective length L of the pipe to an outside diameter D_{O} of the pipe.

6. The high-pressure discharge lamp according to claim 1, wherein the translucent ceramic discharge vessel is 1.4 to 17 in a ratio D_{I}/t of an inside diameter D_{I} of the pipe to a wall thickness t of the pipe.

7. A high-pressure discharge lamp comprising:
a translucent ceramic discharge vessel having a surrounding part, and a pipe connected to the surrounding part and having a smaller diameter than the surrounding part;
a current introducing conductor inserted into the pipe of the translucent ceramic discharge vessel, and sealed at least by a sealing portion formed by fusion of translucent ceramic in the pipe;
an electrode connected to and disposed in the current introducing conductor in the translucent ceramic discharge vessel; and
a discharge medium sealed in the translucent ceramic discharge vessel,
wherein a thermal conductivity difference between a portion of the pipe and a portion of the current introducing conductor, which are located the sealing portion, respectively, is 75 W/m·K or less.

8. A high-pressure discharge lamp comprising:
a translucent ceramic discharge vessel having a surrounding part, and a pipe connected to the surrounding part and having a smaller diameter than the surrounding part;
a current introducing conductor inserted into the pipe of the translucent ceramic discharge vessel, and sealed at least by a sealing portion formed by fusion of translucent ceramic in the pipe;
an electrode connected to and disposed in the current introducing conductor in the translucent ceramic discharge vessel; and
a discharge medium sealed in the translucent ceramic discharge vessel,
wherein a linear expansion coefficient difference between a portion of the pipe and a portion of the current introducing conductor, which are located the sealing portion, respectively, is 4 ppm or less.

9. A high-pressure discharge lamp comprising:
a translucent ceramic discharge vessel having a surrounding part, and a pipe connected to the surrounding part and having a smaller diameter than the surrounding part;
a current introducing conductor inserted into the pipe of the translucent ceramic discharge vessel, and sealed at least by a sealing portion formed by fusion of translucent ceramic in the pipe;
an electrode connected to and disposed in the current introducing conductor in the translucent ceramic discharge vessel; and
a discharge medium sealed in the translucent ceramic discharge vessel,
wherein a thermal conductivity difference between a portion of the pipe and a portion of the current introducing conductor, which are located the sealing portion, respectively, is 75 W/m·K or less, and a linear expansion coefficient difference between the same portions is 4 ppm or less.

10. A high-pressure discharge lamp comprising:
a translucent ceramic discharge vessel having a surrounding part, and a pipe connected to the surrounding part and having a smaller diameter than the surrounding part;
a current introducing conductor inserted into the pipe of the translucent ceramic discharge vessel, and sealed at least by a sealing portion formed by Fusion of translucent ceramic in the pipe;
an electrode connected to and disposed in the current introducing conductor in the translucent ceramic discharge vessel; and
a discharge medium sealed in the translucent ceramic discharge vessel,
wherein a ratio S_{W}/S_{T} is 0.037 to 0.363 where S_{T} is a sectional area of the pipe positioned closer to the sealing portion and S_{W} is a sectional area of the current introducing conductor positioned closer to the sealing portion.

11. The high-pressure discharge lamp according to claim 10, wherein a diameter of the current introducing conductor is 2.5 m or less when a rated lamp power is 800 W or less, 1.5 mm or less when the rated lamp power is 400 W or less, and 0.5 or less when the rated lamp power is 100 W or less.

12. A high-pressure discharge lamp comprising:
a translucent ceramic discharge vessel having a surrounding part, and a pipe connected to the surrounding part and having a smaller diameter than the surrounding part;
a current introducing conductor inserted into the pipe of the translucent ceramic discharge vessel, and sealed at least by a sealing portion formed by fusion of translucent ceramic in the pipe;
an electrode connected to and disposed in the current introducing conductor in the translucent ceramic discharge vessel; and
a discharge medium sealed in the translucent ceramic discharge vessel,
wherein a ratio φ_{S}/φ_{T} is 1 to 2, and a ratio L_{S}/φ_{T} is 1 to 3 where φ_{S} is a maximum outside diameter of the sealing portion, L_{S} is a length of the sealing portion, and φ_{T} is an outside diameter of the pipe positioned closer to the sealing portion.

13. A high-pressure discharge lamp operating apparatus comprising:
the high-pressure discharge lamp according to any one of claims 1, 7, 8, 9, 10 and 12; and
a lighting circuit which lights the high-pressure discharge lamp.

14. An illuminating apparatus comprising:
an illuminating apparatus main body;
the high-pressure discharge lamp according to any one of claims 1, 7, 8, 9, 10 and 12; and
a lighting circuit which lights the high-pressure discharge lamp.
